(19) United States
(12) Patent Application Publication
(10) Pub. No.: US 2004/0141511 A1
(43) Pub. Date: Jul. 22, 2004

(54) Bridging between a bluetooth scatternet and an ethernet LAN

(76) Inventors: Johan Rune, Lidingo (SE); Tony Larsson, Stockholm (SE); Tero Kauppinen, Espoo (FI)

Correspondence Address: Stanley R. Moore, JENKENS & GILCHRIST, A PROFESSIONAl CORPORATION, Suite 3200, 1445 Ross Avenue, Dallas, TX, 75202, US

(21) Appl. No.: 10/735,047

(22) Filed: Dec. 12, 2003

Related U.S. Application Data
(60) Provisional application No. 60/421,132, filed on Dec. 23, 2002.

(51) Int. Cl. H04L 12/28

(52) U.S. Cl. 370/401

(57) ABSTRACT

System and method are disclosed for bridging a point-to-point network such as a Bluetooth scatternet with a shared medium network such as an Ethernet LAN. The scatternet is connected to the LAN via a network access point (NAP). Data packets sent from the LAN to the scatternet are filtered at the NAP to eliminate unnecessary data packets from being sent to the scatternet. Only certain ones of the data packets are forwarded between the LAN and the scatternet. An inter-NAP protocol is used to exchange messages where two or more NAPs are connected to the LAN. Broadcast loops are prevented from occurring in the scatternet and the LAN by defining Administrative domains and NAP service areas (NAPSAs), and controlling the borders thereof according to a broadcast type of the data packets.

### RELATED APPLICATION

This patent application claims priority from and incorporates by reference the entire disclosure of U.S. Provisional Patent Application No. 60/421,132 filed on Dec. 23, 2002.

### BACKGROUND OF THE INVENTION

1. Field of the Invention

The present invention relates to Bluetooth networks and, in particular, to a system and method for connecting a Bluetooth network to an Ethernet LAN.

2. Description of the Related Art

In order to appreciate the merits of the invention a general knowledge of Bluetooth and the problems involved in bridging a Bluetooth network and an Ethernet LAN is in order. Bluetooth is an ad-hoc wireless network technology intended for both synchronous traffic (e.g., voice) and asynchronous traffic (e.g., data traffic) based on IP (Internet Protocol). The aim is that any commodity device such as telephones, PDAs, laptop computers, digital cameras, video monitors, printers, fax machines, etc., will be able to communicate with one another over a radio interface using a Bluetooth radio chip and software. The Bluetooth wireless communication technology uses a frequency hopping scheme in the unlicensed 2.4 GHz ISM (Industrial-Scientific-Medical) band.

Two or more Bluetooth (BT) units sharing the same channel form a piconet. FIG. 1 illustrates several examples of Bluetooth piconets 100-104. Within each piconet 100-104, there must be one and only one master 106 (shaded circles) and up to seven active slaves 108 (empty circles). Any BT unit can become a master 106 in a piconet 100-104.

Furthermore, two or more piconets 100-104 can be interconnected to form a scatternet. FIG. 2 illustrates an example of a scatternet 200 made of several interconnected piconets 202-224. As can be seen, the connection point between any two piconets 202-224 includes one BT unit 226 that is a member of both piconets. The BT unit 226 can simultaneously be a slave member of multiple piconets 202-224, but a master in only one. Partially shaded circles represent BT units 226 that are masters in one piconet while participating as slaves in other piconets. BT units 226 can only transmit and receive data in one piconet at a time, so participation in multiple piconets 202-224 has to be on a time division multiplex basis.

Bluetooth provides packet based full-duplex transmission using slotted Time Division Duplex (TDD). Each time slot is 0.625 ms long and is numbered sequentially using a very large number range (e.g., 2²⁷). Master-to-slave transmission always starts in an even-numbered time slot while slave-to-master transmission always starts in an odd-numbered time slot. An even-numbered time slot and its subsequent odd-numbered time slot (i.e., a master-to-slave time slot and a slave-to-master time slot, except when multi-slot packets are used) together are called a frame. There is no direct transmission between slaves in a Bluetooth piconet.

The communication within a piconet is organized such that the master polls each slave according to some polling scheme. A slave is only allowed to transmit after having been polled by the master. The slave will then start its transmission in the next slave-to-master time slot immediately following the packet received from the master. The master may or may not include data in the packet used to poll a slave. The only exception to the above principle is when a slave has an established Synchronous Connection-Oriented (SCO) link (explained below). When this happens, the slave is always allowed to transmit in a pre-allocated slave-to-master time slot, even if not explicitly polled by the master in the preceding master-to-slave time slot.

Each BT unit has a globally unique 48 bit IEEE 802 address. This address, called the Bluetooth Device Address (BD_ADDR), is assigned when the BT unit is manufactured and is never changed. In addition, the master of a piconet assigns a local Active Member Address (AM_ADDR) to each active member of the piconet. The AM_ADDR, which is only three bits long, is dynamically assigned/de-assigned and is unique only within a single piconet. The master uses the slave's AM_ADDR when polling a slave in a piconet by including the AM_ADDR in the packet header. However, when the slave transmits a packet in response to the master, the slave's own AM_ADDR (not the master's) is included in the packet header.

Even though all data is transmitted in packets, the packets can carry both synchronous data on SCO links mainly intended for voice traffic, and asynchronous data on Asynchronous Correctionless links (ACL). SCO links use regular pre-defined timeslots, as opposed to ACL links which do not have pre-defined timeslots and, therefore, the master has to poll each slave in order to let the slave communicate over the ACL link. Depending on the type of packet that is used, an acknowledgment and retransmission scheme is used to ensure reliable transfer of data. Forward error correction (FEC) in the form of channel coding may also be used to ensure reliable transfer.

The standard format of a Bluetooth packet (except for certain control packets) is shown in FIG. 3. As can be seen, the Bluetooth packet 300 includes a packet header 302, an Access Code 304, and a payload 306. The packet header 302 includes the AM_ADDR followed by one or more control parameters. Examples of control parameters in the packet header 302 include a bit indicating an acknowledgment or retransmission request of the previous packet and a header error check (HEC).

The Access Code 304 in the packet 300 can be of three different types: Channel Access Code (CAC), Device Access Code (DAC), and Inquiry Access Code (IAC). The Channel Access Code identifies the channel that is used in the piconet, which in essence identifies the piconet. All packets 300 exchanged within a piconet carry the same Channel Access Code. The Channel Access Code is derived from the BD_ADDR of the master unit of the piconet. The Device Access Code is derived from the BD_ADDR of a particular BT unit. Device Access Codes are used for special signaling procedures, for example, the PAGE procedure explained later herein. The Inquiry Access Code comes in two variants: the General Inquiry Access Code (GIAC) and the Dedicated Inquiry Access Code (DIAC). Both are used in the INQUIRY procedure explained later herein.

The format of the payload 306 depends on the type of packet 300. For example, the payload 306 of an ACL packet includes a header field, a data field and (with the exception of AUXI type packets) a cyclic redundancy check (CRC). The payload 306 of an SCO packet, on the other hand, includes only a data field. In addition, there are hybrid packets that include two data fields, one for synchronous data and one for asynchronous data. Note that packets 300 in which the payload 306 does not include a CRC are neither acknowledged nor retransmitted.

The protocol layers of a Bluetooth system are illustrated in FIG. 4. Of these layers, the baseband layer 400, link manager protocol (LMP) 402 and logical link control and adaptation protocol 404 (L2CAP) represent existing Bluetooth specific protocols. The high layer protocol or application layer 406 represents protocols that may or may not be Bluetooth specific. Finally, the network layer 408 is currently not specified in the Bluetooth standard, but can in most cases be assumed to be the Internet Protocol (IP).

As previously stated, transmission in a piconet is allowed exclusively between the master and a slave and not between slaves. Furthermore, the addressing scheme requires that the AM_ADDR of the transmitting slave should be used when transmitting to the master. Consequently, there is no way for a slave to send data to another slave in a piconet (there is no way for one slave to address another slave, and direct communication between slaves is not allowed). Hence, a slave can only communicate with the master of the piconet, while the master can communicate with all the slaves.

Another limitation of the Bluetooth system is that, in the current standard, there is no way to address and route packets from one piconet to another. Defining how inter-piconet communication should be performed in a scatternet is one of the tasks that the standardization body Bluetooth Special Interest Group (Bluetooth SIG) is currently working on. This work focuses mainly on the ability of Bluetooth as an ad-hoc network technology to support IP in a Bluetooth scatternet (or piconet). Essentially, IP would run on top of the Bluetooth protocol stack (i.e., IP would be the network layer 408 in FIG. 4). There are currently two basic proposals for how to achieve this: (a) regard each Bluetooth piconet as an IP subnet and run IP on top of the L2CAP layer 404 in each piconet, and (b) regard an entire Bluetooth scatternet as an IP subnet.

The second proposal requires that an adaptation layer be inserted between L2CAP layer and the IP or network layer, as shown in FIG. 5. The purpose of this adaptation layer 500 is to emulate a shared medium network (e.g., a broadcast medium) which is required by the IP or network layer 408. In the Bluetooth SIG, the adaptation layer 500 is referred to as the Bluetooth Network Encapsulation Protocol (BNEP). However, the adaptation layer 500 has also been referred to using the more general term network adaptation layer (NAL). NAL as used herein can refer to any variant or future extension of BNEP or any other adaptation layer 500 with the same basic purpose as BNEP.

The first proposal suffers from a number of problems, one of which is the Bluetooth piconets are not shared medium networks. The second proposal is more promising and has the most support in the Bluetooth SIG. Therefore, the remainder of this description will proceed with the assumption that the second proposal, the NAL/BNEP approach, is used. Furthermore, the more generic term NAL will be used throughout this description.

Both the IP subnet approach and the NAL approach require some kind of routing within a scatternet. In the IP subnet approach, the routing is performed on the IP layer 408. In the NAL approach, the routing is performed on the adaptation layer 500 while appearing (emulating) to the IP layer 408 that the scatternet is actually a single shared medium network. In both cases, the routing can be performed according to several different routing schemes. One scheme may use ad-hoc routing protocols (also called reactive routing protocols) specifically designed for the potentially very dynamic topology of wireless ad-hoc networks. Another scheme may use traditional routing protocols (also called proactive routing protocols) designed for fixed networks with very slowly changing topology. Examples of ad-hoc routing protocols include Ad-hoc On-demand Distance Vector (AODV) and Dynamic Source Routing (DSR). Examples of traditional routing protocols include Distance Vector protocols such as RIP (Routing Information Protocol) and Link State protocols such as OSPF (Open Shortest Path First).

The ad-hoc routing protocols are the ones most seriously considered for Bluetooth scatternets and other ad-hoc network technologies. These ad-hoc routing protocols create routes on demand and retain (or cache) them for a certain period of time based on the time scale for changes of the network topology.

When a route needs to be created in AODV, a route request message is broadcast (i.e., sent to all nodes) in the scatternet. The route request message includes the address of the destination node. As the route request message propagates through the scatternet, temporary route entries are created in the nodes traversed by the message. When the route request message reaches the destination node, the destination node sends a route reply back to the source node. The route reply is unicast (i.e., sent to only one node but possibly forwarded via other nodes) along the same path that the route request message used to reach the destination node, guided by the temporary route entries in the nodes along the path.

As the route reply is forwarded to the source node, a route is created in both directions. Temporary route entries in the nodes through which the route reply does not pass are soon timed out and removed. For the nodes that lie along the path between the source node and destination node, the route entries that are created comprise the address of the destination node and the address of the next node (or hop) in the route. Between the destination node and the source node, route entries that are created include the address of the source node (which is the destination node for packets sent in this direction) and the address of the next hop node in the route. Thus, when a regular packet is subsequently transmitted from the source node to the destination node, all that is needed to route the packet to the destination node is the address of the destination node.

If an intermediate node already has a route entry for a certain destination node, it may return a route reply upon receiving a route request even though it is not the destination node. Such a route reply may also be called a proxy route reply. A node may have several route entries (to different destination nodes) stored. These route entries are together called a routing table and are stored in the node. A route entry is not stored indefinitely and may be removed from the routing table if it is not used for a certain time. The addresses used by the AODV routing protocol are the BD_ADDRs in the NAL approach and the IP addresses in the IP subnet approach.

The DSR routing protocol is similar to AODV in that it uses broadcast route requests and unicast route replies to establish a route on demand. A major difference, though, is that as the route request propagates through the scatternet, the address of each traversed node is added to the route request message. The result is that when the route request message reaches the destination node, it includes the complete route that was traversed. This route is used by the destination node to unicast the route reply message (still including the addresses of all the nodes along the route) to the source node. When a regular packet is subsequently transmitted from the source node to the destination node, the complete route (i.e., the address of all the intermediate nodes and the destination node) is included in the packet. This address information is used by the intermediate nodes to route packet to the destination node. Thus, no address information has to be stored in the intermediate nodes along the route in order to route packets to the destination node. Nevertheless, the intermediate nodes may still use the address information in the route requests and route replies to learn and store routes. As before, if a node already has a stored route for a certain destination node, it may return a route reply even though it is not the destination node. In any case, the stored routes are not stored indefinitely. If the route is not used for a certain time, the route is timed out and removed from the node's routing table. The addresses used by the DSR routing protocol are the IP addresses in the IP approach. In the NAL approach, the BD_ADDRs are used for the destination node, but either the BD_ADDRs or locally unique (i.e., within a single piconet) addresses may be used for the intermediate nodes.

Routing a packet through the scatternet, regardless of which routing scheme is used, relies on the BT units being members in more than one piconet. The BT units forward packets from one piconet to another, and are sometimes referred to as forwarding nodes. Of course, a BT unit may be a member of more than one piconet without forwarding traffic between the piconets. In that case, the BT unit is not a forwarding node. Within each piconet, the master node forwards the packets between different slave nodes. Therefore, master nodes are also referred to as forwarding nodes, even when they are not members of more than one piconet. The address used to route packets within a scatternet in the NAL approach is the BD_ADDR of each node.

The NAL layer can be designed to include functions for automatic network formation. That means that nodes may discover neighbor nodes automatically and connect to each other. Such basic connectivity can facilitate higher-level service discovery that will allow applications to use the network for application layer interactions. Thus, an important capability in any ad-hoc networking technology is the neighbor discovery feature. Without a neighbor discovery procedure, a BT unit would not be able to find any other BT units to communicate with and, consequently, no ad-hoc network would be formed. The neighbor discovery procedure in Bluetooth comprises the INQUIRY message and the INQUIRY RESPONSE message. A BT unit wanting to discover neighboring (within radio coverage) BT units will transmit INQUIRY messages and listen for INQUIRY RESPONSE messages. The INQUIRY message is transmitted repeatedly and according to well specified timing and frequency sequences. An INQUIRY message includes an Inquiry Access Code. The Inquiry Access Code can be a General Inquiry Access Code (GIAC), which is sent to discover any BT unit in the neighborhood, or a Dedicated Inquiry Access Code (DIAC), which is sent to discover only a certain type of BT units.

A BT unit receiving an INQUIRY message (including the GIAC or an appropriate DIAC) will respond with an INQUIRY RESPONSE message. The INQUIRY RESPONSE message is essentially a FHS (Frequency Hop Synchronization) packet being used as a response message. The format of the FHS packet 600, shown in FIG. 6, includes a parity field 602, a Lower Address Part (LAP) field 604, an as yet undefined field 606, a Scan Repetition (SR) field 608, and a Scan Period (SP) field 610. Also included are an Upper Address Part (UAP) field 612, a Non-significant Address Part (NAP) field 614, a Class of Device field 616, the AM_ADDR field 618, a CLK field 620, and a Page Scan Mode field 622. The numbers above each field indicate how many bits in the FHS packet 600 are allocated to each field. All fields in the FHS packet 600, except the AM_ADDR field 618 (and the undefined field 606 of course) indicate properties or parameters of the BT unit that sends the FHS packet. The LAP field 604, UAP field 612 and NAP field 614 together comprise the BD_ADDR. The Class of Device field 616 indicates the device class of the BT unit (e.g., phone, computer, peripheral). The CLK field 620 contains the current value of the BT unit's internal clock. The SR field 608, the SP field 610, and the Page Scan Mode field 602 are control parameters that affect the PAGE procedure. The AM_ADDR field 618 can be used to assign an AM_ADDR to a BT unit that is becoming a slave in a piconet. Otherwise, the three bits of this field should all be set to zero. The Undefined field 606 has two bits reserved for future use, which should be set to zero.

FHS packets are actually used for another purpose in Bluetooth, namely for synchronization of the frequency hop channel sequence. However, by listening for FHS packets used as INQUIRY RESPONSE messages, the BT unit that initiated the INQUIRY procedure can collect the BD_ADDR and internal clock values (both of which are included in the FHS packet) of the neighboring BT units.

Related to the INQUIRY procedure is the PAGE procedure used to establish an actual connection between two BT units. Once the BD_ADDR of a neighboring BT unit is known (as a result of an INQUIRY procedure), the neighboring BT unit can be paged with a PAGE message. Also, knowing the internal clock value of the BT unit to be paged will potentially speed up the PAGE procedure. The paging unit can use the internal clock value to estimate when and on what frequency hop channel the neighboring BT unit will listen for PAGE messages. A PAGE message contains the Device Access Code (DAC) derived from the BD_ADDR of the paged BT unit. A BT unit receiving a PAGE message containing its own DAC responds with an identical packet containing the DAC of the paged BT unit. The paging BT unit then replies with an FHS packet that includes the BD_ADDR of the paging BT unit, the current value of the internal clock of the paging BT unit, the AM_ADDR assigned to the paged BT unit and other parameters. The paged BT unit then responds once again with its DAC and thereby the connection between the two BT units is established.

If the paging BT unit already was the master of a piconet, the paged BT unit has now joined this piconet as a new slave unit. Otherwise, the two BT units have just formed a new piconet with the paging BT unit as the master unit. Since the INQUIRY message does not include any information about its sender (in particular, not its BD_ADDR), the BT unit that initiated the INQUIRY procedure is the only one that can initiate a subsequent PAGE procedure. Thus, the BT unit initiating an INQUIRY procedure will also be the master of any piconet that is formed as a result of a subsequent PAGE procedure. However, if considered necessary, the roles of master and slave can be switched using a master-slave switch mechanism in Bluetooth. (See, e.g., “Specification of the Bluetooth System,” version 1.1, Bluetooth Special Interest Group.)

One of the applications contemplated for Bluetooth scatternets is their use as a wireless ad-hoc extensions to Ethernet LANs. A scatternet can be connected to a LAN through one or more Bluetooth Network Access Points (NAP). This scenario is illustrated in FIG. 7, where the LAN 700 has a scatternet 702 connected thereto via several NAPs 704. The scatternet 702 is similar to the scatternet 200 of FIG. 2 and will therefore not be described here. The NAP 704 is a special type of Bluetooth device that has both a wired Ethernet interface and a wireless Bluetooth interface. In order for the LAN 700 to actually be extended via the NAPs 704, the NAPs 704 must be able to forward packets to and from the LAN on the link layer (see FIG. 5), i.e., it has to be able to act as a bridge between the LAN 700 and the scatternet 702.

A problem with the above contemplated application is that the Ethernet link layers and the Bluetooth link layers are so different. Ethernet is a shared medium technology, i.e., all nodes on the LAN share the same broadcast medium. When a packet is transmitted on the LAN, all nodes connected to the LAN can receive it. The destination address of the packets, however, means that only certain nodes will respond to certain packets.

A Bluetooth scatternet, in contrast, is made up of point-to-point links. In order to overcome this difference, the NAL (see FIG. 5) was developed to emulate a broadcast medium, also called a shared medium. The NAL makes the scatternet appear to be part of a single, shared medium technology LAN. The goal is that all applications designed to run on top of Ethernet, or on top of IP on top of Ethernet, should work equally well (i.e., without adaptations) in a scatternet using the NAL to emulate an Ethernet LAN. Once the NAL broadcast emulation layer is in place, the nodes (BT units) in a scatternet may connect to the NAPs (hence, to the LAN) in an ad-hoc fashion.

The way the NAL emulates the broadcast medium is by making sure that broadcast type packets are delivered to all nodes in the scatternet via the point-to-point links. Unicast packets, on the other hand, are not delivered to all nodes as would be the case on a LAN, since this would waste too much of the limited bandwidth in a scatternet. Instead, unicast packets are delivered to their destination nodes by means of a routing protocol in the NAL. Hence, a unicast packet is routed through a scatternet by the NAL via one or several successive links, while still appearing to the higher layer protocols that the scatternet is a shared medium technology.

However, even with these tools, a number of problems arise. Some of these problems are due to the large difference in capacity between the scatternet and the LAN. The large difference in capacity makes a truly unrestricted extension of the LAN into a Bluetooth scatternet impractical. The scatternet would be suffocated by the traffic from the LAN. Hence, the NAPs have to employ some mechanism to restrict the traffic flowing through them. Other problems are due to the difference in how packets are delivered in the LAN compared to the scatternet. The difference in packet delivery creates a problem of matching the routing protocol of the NAL with the delivery mechanism of the shared medium of the LAN.

Still other problems are due to the ad-hoc nature of a Bluetooth scatternet. The ad-hoc nature of a scatternet creates problems when multiple NAPs are within reach of a scatternet. If the NAPs are attached to the same LAN, broadcast loops can be inadvertently created where packets can flow from the scatternet to the LAN via one NAP and continue through the LAN back to the scatternet via another NAP. If the NAPs are attached to different LANs, the problem is manifested at the IP level where each LAN constitutes one IP subnet. Generally, two different IP subnets or LANs may be connected only via a router which routes packets between the LANs on the IP layer. However, when a scatternet is connected to two NAPs that are attached to different LANs, the router is bypassed. Such bypass of the router can result in problems with IP routing, allocation of IP addresses, and uniqueness of link-local IP addresses.

One solution to the above problems involves the concept of Administrative Domains (AD). An AD corresponds to a broadcast domain, i.e., a LAN and all the nodes that are reachable from the LAN via the NAPs. The AD concept is used to prevent packets from inadvertently flowing from one LAN to another via a Bluetooth scatternet. Within the AD, the NAP is referred to as an Administrative Domain Access Point (ADAP). Each ADAP has a unique identity associated therewith. These identities are used to prevent broadcast loops when a scatternet is attached to one LAN via multiple ADAPs. In such cases, the scatternet is dynamically divided into logical areas corresponding to the ADAPs. The packets are then prevented from crossing from one logical area to another on the scatternet side.

Although the basic principles of the AD are sound, the existing AD solution nevertheless has a number of shortcomings. For one thing, the existing solution is not a complete solution to the bridging problem. In particular, it does not address the forwarding mechanism needed to couple the scatternet routing protocol with the distribution procedure on the LAN. The existing solution also does not address packet filtering to reduce unnecessary traffic in the scatternet.

Secondly, the existing AD model does not address the criteria used by a Bluetooth node for selecting an ADAP, or for changing an ADAP. It also does not address how to handle scatternet “islands” breaking loose from the bridged scatternet, or when a scatternet with two ADAPs splits into two scatternets with one ADAP each.

Finally, the maintenance of existing AD and ADAP areas are too rigid and not dynamic or flexible enough. Such rigidity may result in suboptimal ADAP selections so that the selected ADAP is not the closest one to the node, and may also result in uneven division of a scatternet where there are two ADAPs.

Accordingly, it would be desirable to be able to provide a system and method for bridging a Bluetooth scatternet and an Ethernet LAN that can overcome the shortcomings of the prior art AD model.

### SUMMARY OF THE INVENTION

The present invention is directed to a system and method for bridging a point-to-point network such as a Bluetooth scatternet with a shared medium network such as an Ethernet LAN.

In general, in one aspect, the invention comprises a plurality of nodes in the scatternet and the LAN. The nodes include at least one NAP connecting the scatternet to the LAN. A filtering function is included in the NAP. The filtering function is configured to filter data packets sent from the LAN to the scatternet to eliminate unnecessary data packets from being sent to the scatternet. A bridging function is also included in the NAP. The bridging function is configured to forward certain ones of the data packets between the LAN and the scatternet. Where multiple NAPs are connected to the LAN, an inter-NAP protocol is used to exchange messages between the NAPs. Administrative domains and NAP service areas (NAPSAs) are defined, and the nodes are configured to control the borders of the administrative domain and NAPSAs to prevent broadcast loops in the scatternet and the LAN.

In general, in another aspect, the invention comprises the steps of connecting the scatternet to the LAN via the NAP, and filtering data packets sent from the LAN to the scatternet at the NAP to eliminate unnecessary data packets from being sent to the scatternet. The invention also comprises forwarding certain ones of the data packets between the LAN and the scatternet. The invention also uses an inter-NAP protocol to exchange messages where two or more NAPs are connected to the LAN. Broadcast loops are prevented from occurring in the scatternet and the LAN by defining Administrative domains and NAPSAs and controlling the borders thereof according to a broadcast type of the data packets.

### BRIEF DESCRIPTION OF THE DRAWINGS

A better understanding of the invention may be had by reference to the following detailed description when taken in conjunction with the accompanying drawings, wherein:

FIG. 1 illustrates examples of Bluetooth piconets;

FIG. 2 illustrates an example of a Bluetooth scatternet;

FIG. 3 illustrates a standard Bluetooth packet format;

FIG. 4 illustrates various layers of the Bluetooth protocol stack;

FIG. 5 illustrates a Bluetooth protocol stack that includes a network adaptation layer;

FIG. 6 illustrates a standard FHS packet format;

FIG. 7 illustrates an example of a Bluetooth scatternet attached to a LAN;

FIG. 8 illustrates an exemplary implementation of a scatternet attached to one or more LANs via NAPs;

FIG. 9 illustrates the functional structure of a NAP;

FIG. 10 illustrates the broadcast areas for the NAPSA broadcast type;

FIG. 11 illustrates the broadcast areas for the scatternet broadcast type for NAL packets containing higher layer protocols;

FIG. 12 illustrates the broadcast areas for the scatternet broadcast type for NAL control messages;

FIG. 13 illustrates the broadcast areas for the AD broadcast type;

FIG. 14 illustrates the broadcast area for an ARP-route-request;

FIG. 15 illustrates the broadcast area for a non-ARP-rout-request;

FIG. 16 illustrates two exemplary routes;

FIG. 17 illustrates Ethernet and NAL packet formats;

FIG. 18 illustrates NAPSA edge nodes;

FIG. 19 illustrates the message sequence during a NAPSA switch;

FIG. 20 illustrates the INAPP message format; and

FIG. 21 illustrates the NAL message format.

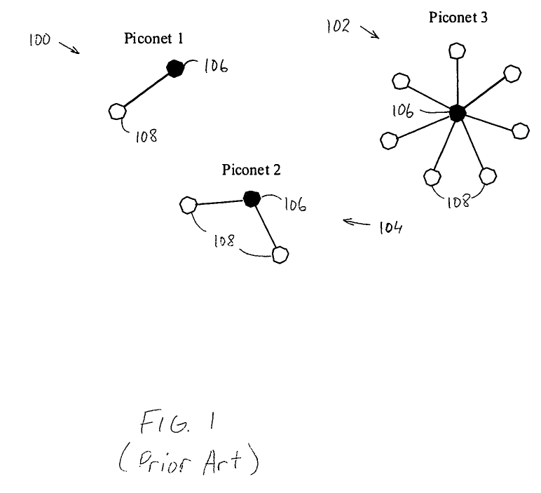

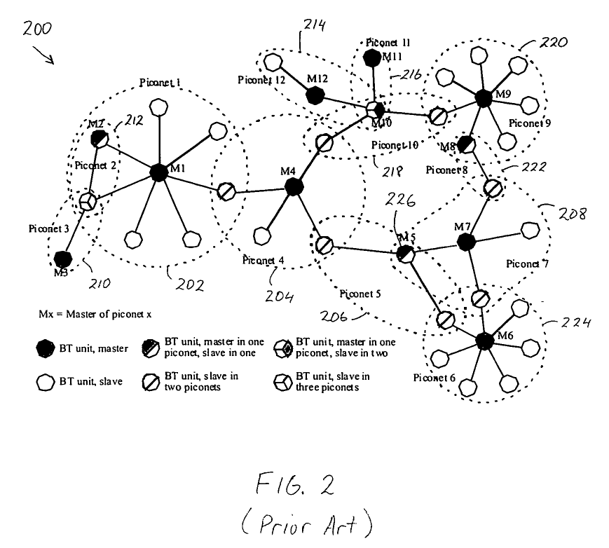

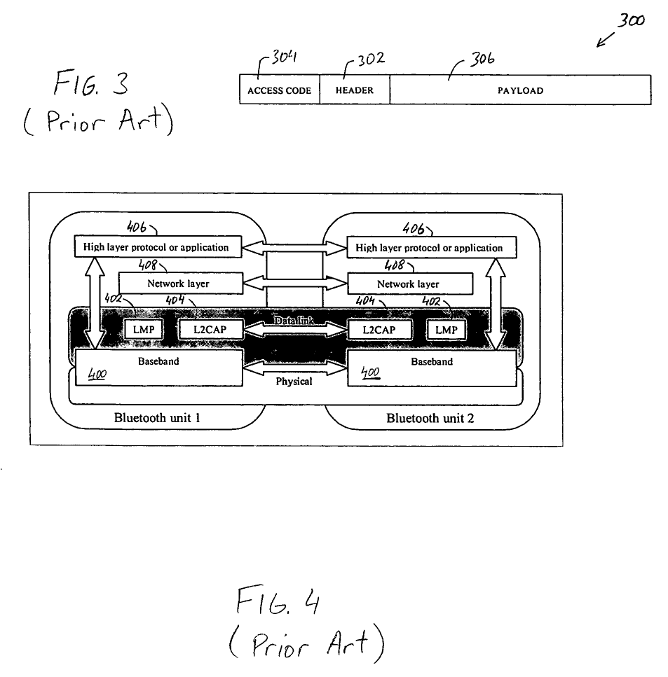

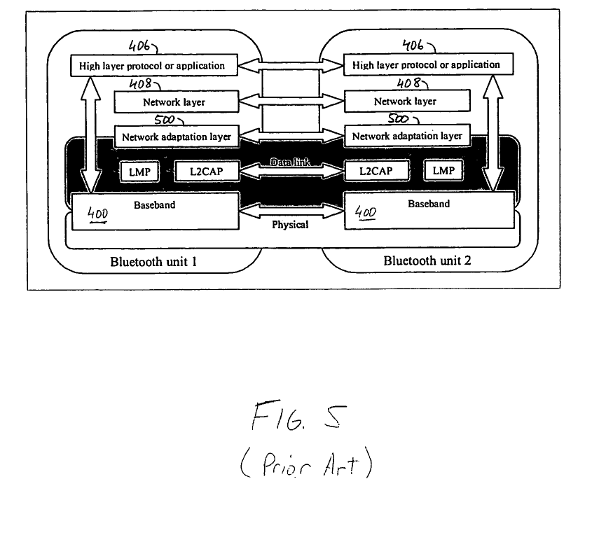

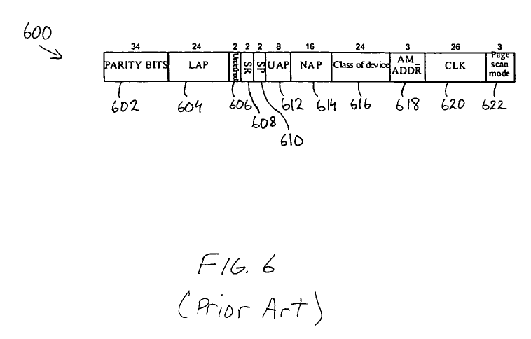

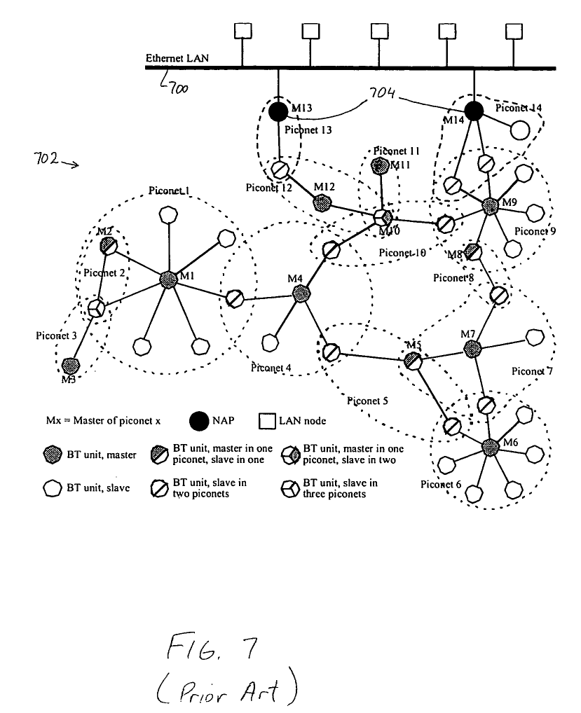

### DETAILED DESCRIPTION OF THE EXEMPLARY EMBODIMENTS

Embodiments of the invention provide a system and method for bridging a Bluetooth scatternet and an Ethernet LAN. Although the system and method of the invention includes a number of functional features and components, the primary components of the invention are: a packet conversion and forwarding mechanism; a packet filtering mechanism; Administrative Domains (ADs) and NAP Service Areas (NAPSAs); and an Inter-NAP protocol (INAPP). Each of these components will be introduced briefly here, then discussed in more detail below along with the other features and components of the invention.

The first main component, the packet conversion and forwarding mechanism, requires the NAP to convert and forward the packet traffic between the nodes in the scatternet and the nodes on the LAN, and vice versa. Conversion is needed because on the LAN side, data is transported in Ethernet packets (also known as Ethernet frames), while on the scatternet side, data is transported in NAL packets. Therefore, packets passing from one side to the other need to be converted between these two different packet formats. Fortunately, the conversion is a straight forward procedure, since the same MAC (Media Access Control) addresses are used in both packet formats. (Note the MAC addresses are referred to as BD_ADDR in Bluetooth devices.)

Packet forwarding on the scatternet requires the NAP to treat unicast packets and broadcast packets differently due to the limited capacity of the scatternet. Unicast packets are forwarded using the NAL routing protocol to establish individual routes, while broadcast packets are distributed using the NAL broadcast emulation mechanism. For a proper understanding of the invention, it is necessary to understand the distinction between these two packet forwarding techniques. On the LAN side, there is no fundamental difference between transmitting a unicast packet and a broadcast packet, since Ethernet is a shared medium technology. Thus, all packets are forwarded to all nodes on the LAN and individual routes are not needed. Each node then chooses whether to receive or discard a packet based on the packet's destination address.

The second main component, the packet filtering mechanism, prevents the NAP from indiscriminately forwarding every packet it receives, particularly when there is no receiver on the other side. Filtering is especially important for the scatternet, which would otherwise be flooded by traffic from the higher capacity LAN. The filtering is performed based on (1) the destination address of the packet, (2) the higher layer protocol type specified in the payload of the packet, and for packets from the scatternet, (3) the NAL packet type. The higher layer protocol type filtering is considered to be more of a configuration issue that should be handled by the network administrator and will not be discussed herein.

The third main component, Administrative Domains (ADs) and NAP Service Areas (NAPSAs), prevents packets from being sent across two or more different LANs via the scatternet. The ADs and NAPSAs can be better explained with reference to FIG. 8. As can be seen, an exemplary network 800 according to embodiments of the invention may include a first LAN 802 and a LAN segment 802a. The first LAN 802 may be connected to a second LAN 804 by a network router 806 (shown as a box with a circled “R”). A network bridge 808 (shown as a circled “B”) connects the first LAN 802 to the LAN segment 802a. Scatternets 810 and 812 may be connected to the LANs 802, 802a and 804 to thereby extend the scope of the LANs. In particular, a single scatternet 810 may be connected to two or more different LANs 802 and 804, or two or more different scatternets 810 and 812 may be connected to the same LAN 802 and 802a.

The scatternets 810 and 812 are connected to the LANs 802, 802a and 804 via one or more NAPs, namely NAPs 1-5, as shown. Scatternets with more than one NAPs are divided into different NAPSAs. Thus, in FIG. 8, each NAP 1-5 has a respective NAPSA 1-5 associated therewith. The borders of the NAPSAs 1-5 (dashed lines) are defined by the nodes (not expressly shown) that belong to each NAP 1-5. Each node in the scatternet can belong to only one NAPSA at a time. The purpose of the NAPSAs is to prevent broadcast loops and duplicate packet deliveries when multiple NAPs act as bridges between the same LAN and scatternet. Note that there is one pocket of nodes that does not have a NAP. These nodes may be an island 814 of nodes that does not belong to any particular NAP and, therefore, is not connected to the LANs 802, 802a, and 804.

A LAN together with the NAPSAs of the NAPs that are connected to the LAN define one AD. NAPs that are attached to different LANs must belong to different ADs. For example, NAPSAs 1-4 define one AD, namely AD 1, because the respective NAPs 1-4 are all connected to the same LAN 802. On the other hand, NAPSA 5 associated with NAP 5 defines a different AD, namely AD 2, because this NAP is connected to a different LAN 804. Each AD represents one broadcast domain (as mentioned earlier) and is identified by a unique Administrative Domain Identifier (ADI). A node belongs to the same AD as its NAPSA.

If packets are bridged across different broadcast domains or ADs, problems may arise at the IP level due to bypass of the router 806. Therefore, the NAL will not send packets containing higher layer protocols across an AD border. A packet may traverse a NAPSA border, however, provided it is not also forwarded by a NAP. This prevents broadcast loops and duplicate packet deliveries.

The fourth main component, the Inter-NAP protocol (INAPP), enables NAPs to exchange information across the LAN. This mechanism is useful both to facilitate packet filtering and to improve forwarding of packets from one scatternet to another across the LAN.

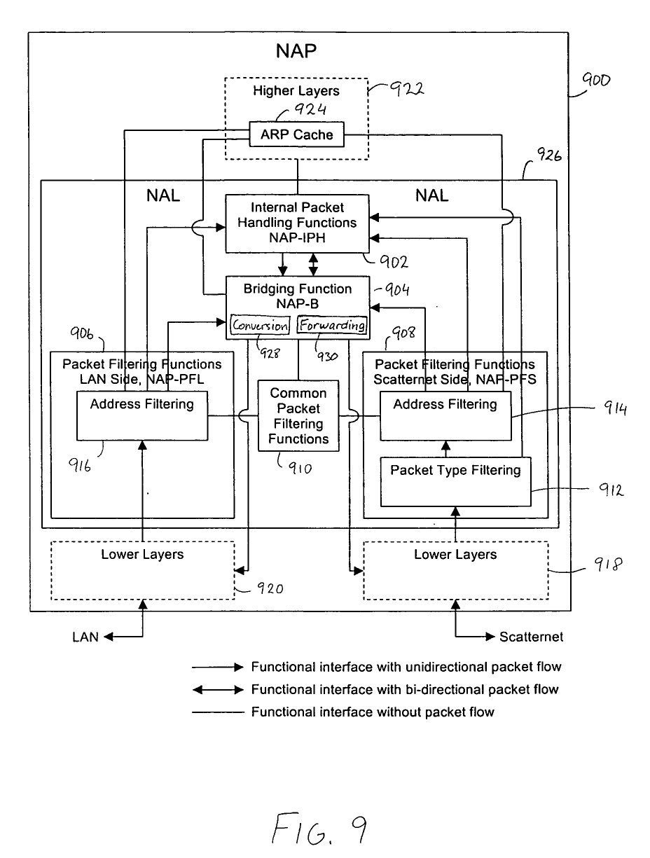

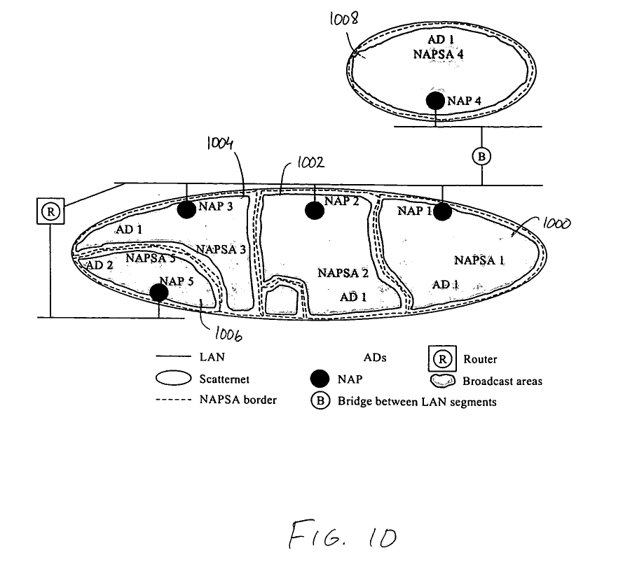

To better understand these four primary components, it may be helpful to have an understanding of the structure of the NAP and the NAL routing protocol and broadcast mechanism (which exist in all BT nodes). Reference is now made to FIG. 9, where the functional structure of a NAP 900 is shown according to some embodiments of the invention. As can be seen, the NAP 900 includes an internal packet handling function 902 (NAP-IPH), a bridging function 904 (NAP-B), a LAN side packet filtering function 906 (NAP-PFL), a scatternet side packet filtering function 908 (NAP-PFS), and a common packet filtering function 910. The scatternet side packet filtering function 908 includes a packet type filtering function 912 as well as an address filtering function 914. The LAN side packet filtering function 906 does not have a packet type filtering function, only an address filtering function 916. The above functions are all located at the NAL 926 of the NAP 900, and may be implemented as software, hardware, or a combination of both. For nodes that are not NAPs (i.e., regular BT nodes), the NAL does not have these functions.

A packet that is received on the scatternet side of the NAP is passed through the scatternet side lower layers (shown generally at 918) to the packet type filtering function 912. Note that such a packet will likely be an NAL packet, since it was received from the scatternet. The packet type filtering function 912 can pass the packet either to the address filtering function 914 or the internal packet handling function 902, or it may discard the packet. The address filtering function 914 may also discard the packet, or it may pass the packet either to the bridging function 904, or to the internal packet handling function 902 if the packet is addressed to the NAP itself. The bridging function 904 will in most cases forward the packet to the lower layers on the LAN side (shown generally at 920), but in some cases the packet may be discarded. If the packet is a broadcast packet, the bridging function 904 will, in most cases pass the broadcast packet to the internal packet handling function 902 in addition to forwarding it to the LAN side lower layers 920.

An Ethernet packet that is received on the LAN side of the NAP is passed through the LAN side lower layers 920 to the address filtering function 916. The address filtering function 916 can pass the packet either to the bridging function 904, or to the internal packet handling function 902 if the packet is addressed to the NAP itself, or the packet may be discarded. The bridging function 904 will in most cases forward the packet to the lower layers 918 on the scatternet side, but in some cases the packet may be discarded. If the packet is a broadcast packet, the bridging function 904 will, in most cases, pass the broadcast packet to the internal packet handling function 902 in addition to forwarding it to the scatternet side lower layers 918. The bridging function 904 also handles the broadcast emulation on the scatternet side as well as conversion between NAL packet format and Ethernet packet format.

A packet that originates in the higher layers 922 of the NAP will be passed via the internal packet handling function 902 to the bridging function 904 (along with packets that originate in the internal packet handling function). The bridging function 904 will consult the common packet filtering function 910 to find out whether the LAN interface or the scatternet interface, or both, will be used to send the packet. The packet is then sent via the lower layers 918 or 920 of the indicated interface(s). It should be noted that the NAP will only receive packets from the higher layers 922 if there are higher layers present in the NAP. Some NAPs, however, may only have NAP functionality, i.e., no applications functionality and, hence, no higher layers.

Referring still to FIG. 9, an address resolution protocol (ARP) cache 924 is also included in the NAP 900, though not in the NAL 926. ARP is a protocol used by the IP layer of the nodes in a network to map IP network addresses to MAC addresses. The mapping of the IP address and the MAC address is then stored in the ARP cache 924. Both the bridging function 904 and the packet filtering functions 906 and 908 have access to the ARP cache 924. However, access to the ARP cache 924 is a feature specially designed for the NAP of the present invention. For Bluetooth devices in general, there is no such access because the ARP cache resides in the higher layers 922 in the protocol stack and, therefore, is independent of the Bluetooth specific layers. For the same reason, the NAP 900 of the present invention can be aware of or can know its own IP address, while Bluetooth devices in general cannot.

For all nodes in a network, whether in the LAN or in the scatternet, communication between any two nodes starts with the first node sending a broadcast ARP request to get the IP address of the second node translated to a MAC address. The MAC address is then used to send the message to the second node. Once an IP address has been translated to a MAC address, the IP-MAC address pair is temporarily stored in the ARP cache of the first node. When subsequent packets are to be sent to the second node, the MAC address of the second node can be retrieved from the ARP cache of the first node. Hence, the subsequent packet can be sent without a preceding ARP request.

Within each node, the ARP cache is updated or refreshed by all ARP packets received by the node that include a valid IP-MAC address pair. Each entry (i.e., address pair) in the ARP cache has a timer that is restarted every time the entry is updated or refreshed. When the ARP cache timer for a certain entry expires, the entry is removed.

In the scatternet, unicast packets are delivered by the NAL routing protocol. The NAL routing protocol used is a reactive routing protocol that can establish a route through the scatternet. A reactive routing protocol creates routes only when they are needed, as opposed to a proactive routing protocol that attempts to maintain a route to all nodes in the network at all times. There are several different reactive routing protocols designed for ad-hoc networks (e.g., the DSR protocol mentioned previously) and the specific one used is not essential for the invention. However, to simplify the description of the invention, it is assumed that the NAL routing protocol used will be based on the AODV protocol mentioned earlier.

In reactive routing, a route request message is broadcast (not unicast) in the scatternet whenever a route needs to be created. The route request message typically includes the address of the destination node. As the route request message propagates through the scatternet, temporary routes back to the source node are created (in the form of temporary route entries) in the routing tables of the nodes traversed by the message. The traversed nodes will also store the route request packet's identity, which includes the source node address and a sequence number assigned by the source node. This packet identity is used to prevent broadcast loops, as will be explained later in more detail.

The traversed node also starts a timer for the route entry, referred to as a route entry timer. The route entry timer governs how long the node will keep the temporary route entry without having received a route reply that makes use of the temporary route entry. That is, the timer effectively governs how long the node will wait for route replies for a particular route request. When a temporary route entry is first created, the route entry timer is set to a short timer interval called shortInterval, which may be a few seconds long, for example.

When a route request message reaches the destination node, the destination node returns a route reply. The route reply is unicast (not broadcast) along the same path used by the particular route request to reach the destination node, guided by the temporary route entries of the various nodes along the way. As the route reply is forwarded to the source node, a route is established in both directions. The route entry timer in each node along the path is then set to a significantly longer time interval longInterval which may be a minute, for example. Thus, the only difference between a temporary route entry and a regular route entry for an established route is the duration of the route entry timer.

The route request message will accumulate a hop count, which is the number of hops that it has made. Each intermediate node traversed counts as one hop. The route reply message includes the total hop count accumulated by the route request message. An intermediate node can thus calculate the hop count to the destination node by subtracting the hop count to the source node (received in the route request and stored in the temporary route entry) from the total hop count (received in the route reply).

The temporary route entries in all other nodes through which the route reply did not pass are timed out upon expiration of the respective route entry timers and removed along with the route request's identity. In the nodes along the route from the source node to destination node, the created route entries mainly include the address of the destination node, the address of the next node in the route, and the hop count to the destination node. Similarly, in the other direction, the created route entries include the address of the source node (which is the destination node for packets sent in this direction), the address of the next node in the route, and the hop count to the source node (which is the destination node for packets sent in this direction).

At the sending node, the start of a route request initiates a timer, denoted route reply timer. The route reply timer governs how long the sending node will wait for a route reply. If the timer expires, the node usually resends the route request and restarts the timer for a predetermined number of times until a route reply is received. If no route reply has been received after the maximum number of repeated route requests have been sent, all packets that were waiting for the route to be established are discarded, and an indication of this may be passed to the higher layers. To simplify the description of the invention, however, it is assumed that a node will send only one route request. When the route reply timer associated with this route request expires, the node gives up. The timeout period of the route reply timer should preferably be the same as for the route entry timer for temporary route entries, or perhaps somewhat longer. For example, the route reply timer could be started at the value routeReplyTimeoutPeriod=1.2×shortInterval.

When a route reply is received, the receiving node checks its routing table to see whether it already has a route entry for the node that sent the route reply (i.e., the destination node). If yes, the hop count of the old route entry is compared with the one in the received route reply. If the hop count in the received route reply is smaller than or equal to the hop count of the old route entry, the old route entry is replaced with a new one. If no route entry was found, the node creates a route entry for the node that sent the route reply. In either case, the node starts a route entry timer for the new route entry with the value longInterval. If the hop count in the received route reply is greater than the one in the old route entry, the old route entry is kept.

If the route reply was addressed to the receiving node itself, the receiving node does not need to do anything else. Otherwise, the node checks its routing table to see whether it has a route entry for the node to which the route reply is addressed (i.e., the source node). If yes, the node restarts the route entry timer for the found route entry with the value longInterval, and forwards the route reply to the next node indicated by the found route entry. If no route entry is found, the route reply is discarded.

Thus, when a packet is subsequently transmitted from the source node to the destination node, the only information needed in the packet for routing purposes is the address of the destination node (and likewise in the other direction). Every time an existing route entry is used to route a packet, its route entry timer is restarted with the value longInterval.

If a node that already has a route entry for a certain destination node receives a route request for that destination node, it may return a route reply, even though it is not the destination node. Hence, some nodes may receive several route replies to the same route request (recall that the route request message was broadcast to all the nodes in the scatternet). These nodes will initially use the route that is established by the first route reply. If a subsequent route reply is received that has a lower hop count to the source node, the receiving node will replace the existing route with the new route.

Hop count comparison is also performed in the handling of route request messages. In general, when a node receives a route request, it checks to see whether a route entry back to the source node already exists. If yes, the hop count of the existing route entry is compared with the hop count in the route request. If the hop count in the received route request is greater than that of the existing route entry, the existing route entry is kept. If the hop count in the received route request is smaller than the hop count in the existing route entry, or if they are equal, the existing route entry is replaced with a new route entry. When this happens, a route entry timer for the new route entry is started using the current value of the route entry timer for the existing route entry. In essence, the new route entry timer is a continuation of the existing route entry timer.

The node receiving the route request may also check to see whether the current route entry timer value of the existing or the new route entry is less than shortInterval. If yes, the node may restart the route entry timer at the value shortInterval.

If no route entry for the source node was found in the receiving node, the receiving node creates a new route entry for the source node. A route entry timer for this new route entry is then started at the value shortInterval (i.e., the new route entry is a temporary route entry). The node then checks to see whether it has a route entry for the destination node of the route request (unless the route request is addressed to the receiving node itself). If yes, the node restarts the route entry timer for the destination node route entry using the value longInterval and returns a route reply to the source node. If the node does not have a route entry for the destination node, it forwards the route request to its neighbors (except, of course, the neighbor from which the route request was received).

If the route request is addressed to the receiving node itself, the receiving node either creates a new route entry for the source node, replaces an existing one, or keeps the existing route entry (according to the hop count comparison procedure described above). It then starts the timer of the route entry for the source node at the value longInterval and sends a route reply to the source node using the route entry for the source node.

A node may have several route entries to different source and destination nodes stored. These route entries are together called a routing table and are stored in a memory area that is accessible to the NAL entity in the BT node. (The NAL entity is a software and/or hardware based functional entity that handles the NAL functionality.) When a route entry's timer expires, the route entry is removed from the routing table. Thus, if a route entry has not been used for routing a packet for a time equal to longInterval, the route entry is timed out and removed.

Sometimes a route “breaks” before it is timed out. This happens when one of the links along the route is broken or otherwise becomes no longer available. There are two mechanisms to deal with route failures. The first mechanism is triggered by detection of a link loss. When a node with more than one link established detects that the link to one of its neighbors is lost, it checks to see whether it has any entries in its routing table that indicate the now unreachable neighbor as the next hop node. If yes, the node will remove these route entries.

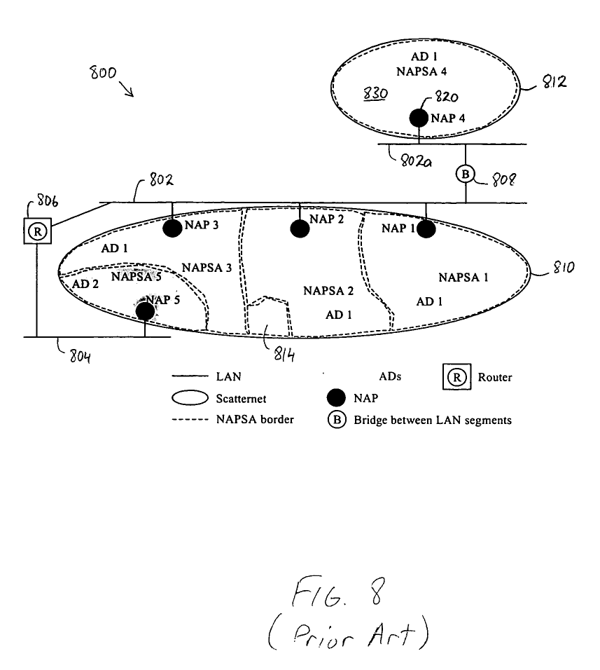

If any of the node's remaining neighbors also use any of the broken routes, the node sends a “route failure” message to those of its remaining neighbors that are affected by the route failures. Referring back to FIG. 7, the neighbor nodes are the nodes that are directly connected to each other (illustrated with a solid line). The route failure message includes the destination addresses of all the broken routes that are used by the particular neighbor. These neighbors will then, in turn, check to see if they have any affected route entries and, if so, remove the affected route entries and forward the route failure message to their affected neighbors (if any). Before the route failure message is forwarded, its content is updated to reflect the affected routes. In this way, the route failure message is propagated to all the affected nodes in the scatternet.

Before sending the route failure messages, a node needs to know which of its neighbors are affected by the route failure. This information is required to prevent the node from indiscriminately forwarding the route failure message to all neighbors. In the NAL routing protocol, the issue is resolved by associating a dependent neighbors table with each affected route entry in the node. The nodes in the dependent neighbors table are the upstream nodes that are dependent on the present node to provide the next hop in any route. Every time a node forwards a route reply (or sends a proxy route reply) for a certain route, the neighbor to which the route reply is sent is included in the forwarding node's dependent neighbors table. The table is then associated with the route entry for the route in which the neighbor is an upstream node (i.e., the route to the destination node in this case). In addition, the neighbor from which the route reply was received (unless it was a proxy route reply) is included in the table, and the table is associated with the route entry for the opposite route (i.e., the route to the source node). Using these dependent neighbors tables, the node can keep track of which of its neighbors depend on each of the node's routes.

Table 1 below illustrates an example of a dependent neighbors table for node M4, referring once again to FIG. 7. It should be emphasized that Table 1 is exemplary only (i.e., only the parameters relevant for illustrating this feature have been included), and that other formats may certainly be used. As can be seen, each route entry in node M4 lists a destination node, a next hop node, and zero, one or more dependent upstream neighbor nodes. In the route entry for node M1, for example, node S1 is listed as the next hop node, and nodes S2 and S3 are listed as the dependent upstream neighbor nodes. Nodes S2 and S3 are listed because these are the nodes to which node M4 has sent route replies concerning node M1. When a break is detected between node M4 and the next hop node, node S1, node M4 sends a route failure message (also called a route error message) to node S2 indicating that the route to node M1 is broken. Node M4 also sends a route failure message to node S3 indicating that the routes to both node M1 and node M3 are broken, since these are the affected route entries for which node S3 is indicated as a dependent upstream neighbor node. In this way, node S3 can know all the route entries that are affected by the break.

TABLE 1

| Destination | Next Hop | Dependent |
|---|---|---|
| Node | Node | Upstream Neighbors |
| M1 | S1 | S2, S3 |
| M3 | S1 | S3 |
| ... | ... | ... |
| M9 | S2 | S1, S4 |

Note that the dependent neighbors table informs the upstream neighbors only. There is presently no way to inform a downstream neighbor that one of the routes of the downstream neighbor is no longer available. Therefore, no neighbors will be removed from the dependent neighbors table, except when the link to such a neighbor is broken (and the whole table will of course be removed when the route entry is removed). Thus, the table may sometimes contain neighbors that actually are no longer dependent on the associated route entry. Consequently, the route failure message may sometimes be needlessly sent to unaffected neighbors. Nevertheless, the dependent neighbors tables still serve to significantly limit the number of nodes to which a route failure message is propagated.

The above described NAL routing protocol must be coupled with ARP in order to bridge a Bluetooth scatternet with an Ethernet LAN. That is to say, the NAL routing protocol must be able route an ARP request through the scatternet in order to bridge a scatternet with a LAN. Therefore, the ARP request is included, or piggybacked, in a NAL route request. The ARP reply (if any) will likewise be piggybacked on a NAL route reply. The result is that when the IP address of the destination node is translated to a MAC address, the route through the scatternet is already established so that subsequent packets can be delivered without a route request. To achieve this end, the NAL includes functionality to monitor or “snoop” every ARP packet it receives from the higher layers before the ARP packet is sent.

Regular route requests (without piggybacked ARP requests) will of course still be used. For example, when the MAC address of the destination node is known (e.g., from the ARP cache), there is no need to send an ARP request. In this situation, a regular route request will be sent if the node does not already have a route entry for the destination node.

The piggybacking of ARP requests on route requests and ARP replies on route replies is well known and, therefore, will be described only briefly here. For convenience, a route request with a piggybacked ARP request will be referred to as an “ARP-route-request,” while a route request without a piggybacked ARP request will be referred to as a “regular route request” or a “non-ARP-route-request”. The term “route request” will henceforth refer to any route request generally, with or without an ARP request piggybacked thereon. Similarly, a route reply with a piggybacked ARP reply will be referred to as an “ARP-route-reply,” while a route reply without a piggybacked ARP reply will be referred to as a “regular route reply” or a “non-ARP-route-reply.” The term “route reply” will henceforth refer to any route reply in general, with or without an ARP reply piggybacked thereon. ARP requests and ARP replies will continue to be referred to as such.

When a node sends an ARP-route-request, it follows the same procedure as previously described for a node sending a regular route request. An ARP-route-request would be sent instead of a regular route request when the IP address of the destination node is known, but not the MAC address. Thus, the only difference between a regular route request and an ARP-route-request is the ARP-route-request does not contain the MAC address of the destination node (since this address is not known). In addition, only the destination node can reply to an ARP-route-request. Proxy replies by intermediate nodes (as is the case for regular route request) are not allowed. This means that in a stand-alone scatternet or a scatternet connected to only a single NAP, a node can (in most situations) receive only one ARP-route-reply to an ARP-route-request. Reception of more than one ARP-route-reply by a node indicates that more than one node is using the same IP address. Such an error would be obvious also from the fact that the MAC addresses of the nodes sending the route replies would be different. However, in a scatternet connected to more than one NAP, it is perfectly normal to receive two ARP-route-replies in response to the same ARP-route-request (as will be explained later).

All nodes that receive an ARP-route-request will pass it to the higher layers where the request can be processed by the ARP entity, which is a software and/or hardware based functional entity that handles the ARP protocol and the ARP cache. This occurs regardless of whether the node forwards the ARP-route-request or terminates it (e.g., when the receiving node itself is the destination node of the ARP-route-request). The ARP entity will then update or refresh the ARP cache with the IP address and MAC address of the node sending the ARP request. The receiving node will also reply to the ARP request if it happens to be the destination node.

In addition, when a node receives an ARP-route-request, it checks whether a route entry for the source node already exists. If yes, the hop counts of the current route entry is compared with the one in the received ARP-route-request. If the hop count in the received ARP-route-request is greater than that of the current route entry, the current route entry is kept. If the hop count in the received ARP-route-request is smaller than the hop count of the current route or if they are equal, the current route entry is replaced with a new one. The route entry timer of the new route entry is then started at the current value of the route entry timer of the existing route entry. Regardless of which route entry is used, if the current value of the route entry timer for the route entry is less than shortInterval, the node may restart the timer at the value shortInterval. If no route entry was found, the node creates a new route entry for the source node and starts the route entry timer for this new route entry at the value shortInterval (i.e., it makes the new route entry a temporary route entry). The node then forwards the ARP-route-request to its neighbors (except the one from which it was received) unless the ARP-route-request is addressed to the node itself.

If the ARP-route-request is addressed to the node itself, the node either creates a new route entry for the source node, replaces the current route entry, or keeps the current route entry, depending on the hop count comparison procedure described above. The node then starts the timer of the route entry for the source node at the value longInterval and sends an ARP-route-reply to the source node using the route entry therefor.

The foregoing assumes that the NAL entity knows the node's own IP address, which is not necessarily the case for a Bluetooth device in general. If the node does not know its IP address, it can easily find out by monitoring or snooping the ARP replies passed down from the higher layers (which it does anyway). An ARP-route-request addressed to the node itself that is received before the NAL has discovered the node's own IP address is treated just like any ARP-route-request that is addressed to another node (i.e., the request will be forwarded to the next node). However, since the piggybacked ARP request is passed to the higher layers, an ARP reply will soon be returned from the higher layers. By snooping the “sender IP address” from this ARP reply, the NAL can know the node's IP address. Hence, no more than a single ARP-route-request will be incorrectly forwarded by a node before the NAL entity of the node learns the node's own IP address.

Although snooping ARP replies from the higher layers is very convenient, it is not the only way for the NAL entity to learn the node's own IP address. The NAL entity may have learned the IP address of the node before the first ARP-route-request is received. One way to do this is, when the node is sending an ARP-route-request, the NAL can snoop the “sender IP address” in the ARP request passed down from the higher layers (e.g., from the ARP entity that is responsible for processing ARP packets). This approach is convenient since the NAL snoops all ARP packets from the higher layers anyway. The NAL can snoop the “sender IP address” in the ARP-route-replies received by the node. It can snoop the source IP address in the IP header of any IP packet passed down from the higher layers. It may also snoop a DHCP (Dynamic Host Configuration Protocol) message that assigns the IP address to the node (provided that DHCP IP address allocation is used). It could retrieve the node's IP address from the ARP cache, provided that the NAL has access to the ARP cache and that the ARP cache contains the node's IP address.

The coupling between AODV and ARP will also work in cases where the NAL entity has no possibility to learn its own IP address(es). This can be handled by always delivering the ARP request packet that was piggybacked on a route request to the higher layers, as alluded to above. Thus, all nodes will first create a temporary route back to the source, then deliver the ARP request packet to the ARP entity. The higher layer ARP entity will generate an ARP reply if the ARP request was destined to this node. This ARP reply, when received by NAL, will convert the temporary route entry (back to the source) into a regular route entry. The ARP reply will then be piggybacked on a regular route reply and sent back to the source node as an ARP-route-reply.

When a node receives the ARP-route-reply it follows the same procedure as previously described for a node receiving a regular route reply.

For an ARP reply containing a link-local sender IP address (i.e., an IP address in the range 169.254.0.0-196.254.255.255), presently existing protocols call for the node to broadcast (not unicast) the link-local ARP reply. Broadcasting the link-local ARP reply facilitates the detection of duplicate link-local IP addresses. However, in order to save bandwidth in the scatternet the broadcast provision may be overridden by the NAL, which is snooping all ARP packets anyway. The NAL then extracts the target MAC address from the ARP reply coming from the higher layers and replace the broadcast destination address therein with the extracted MAC address. The link-local ARP reply is then unicast (not broadcast) while piggybacked on a route reply. Alternatively, if the link-local ARP reply was triggered by a regular ARP request, the link-local ARP reply would be unicast as a regular ARP reply. Note that normally, ARP requests and ARP replies from the LAN are converted to ARP-route-requests and ARP-route-replies when sent into the scatternet. However, it is possible to send unconverted ARP requests and ARP replies to the scatternet. One example of an ARP request that can be sent unconverted into the scatternet is a so-called “ARP probe.” An ARP probe is used whenever a node claims a link-local IP address. The ARP probe is basically an ARP request with the sender IP address field set to all zeros. The sender hardware address field should be set to the sender's MAC address. The target node's hardware address should be all zeros and the target node's IP address should be the claimed link-local IP address.

Another example of an ARP request that should be sent uncoverted into the scatternet is a so-called “gratuitous ARP request.” Gratuitous ARP requests are also used in the process of autoconfiguration of link-local IP addresses. They are sent by a node that has successfully claimed a new link-local address, and may also be sent by a node that “defends” its link-local address when another node tries to claim the same address. A gratuitous ARP request is an ARP request with the target IP address field and the sender IP address field set to the same address, namely, the IP address of the sender. The sender hardware address field is set to the MAC address of the sender, and the target hardware address field is set to all zeros.

As for broadcast ARP replies, they may be sent unconverted into the scatternet as mentioned earlier in order to facilitate detection of duplicate link-local IP addresses. Otherwise, an ARP reply from the LAN is sent unconverted into the scatternet only if it is sent in response to an unconverted ARP request from a node in the scatternet (but a node in the scatternet normally does not use plain ARP requests, but instead uses ARP-route-requests).

If the NAL does not override the broadcast ARP replies, then the reply to an ARP-route-request concerning a link-local IP address is both an ARP-route-reply and a broadcast ARP reply. In such cases, the broadcast ARP reply must be sent after the ARP-route-reply. Furthermore, the type of broadcast packet (different types of broadcast packets will be described later) to use for the broadcast ARP reply depends on the type of broadcast packet in which the ARP-route-request was received. If the ARP-route-request was received by a node via a scatternet broadcast packet, the broadcast ARP reply should be sent in a scatternet broadcast packet. The reason for these rules will be clarified further below.

In addition to the ARP-route-request and ARP-route-reply, an extension of the NAL routing protocol called the “unconfirmed proxy non-ARP-route-reply” may be used in accordance with embodiments of the invention. An unconfirmed proxy non-ARP-route-reply is a proxy non-ARP-route-reply with an indication that neither the destination node nor a node with a route to the destination node has confirmed the route. Normally, a proxy non-ARP-route-reply is sent by an intermediate node that has a route entry for the destination node. When a source node (of the original non-ARP-route-request) receives an unconfirmed proxy non-ARP-route-reply before it has received any other non-ARP-route-reply, the source node creates a route entry and marks the route entry as “unconfirmed.” It may then start to use the unconfirmed route immediately, or it may choose to wait until the route reply timer expires before it starts to use the unconfirmed route. The reason for waiting for the route reply timer to expire is that a confirmed (i.e., regular) non-ARP-route-reply may arrive in the meantime and then the node would not have “wasted” packets on a possibly dead end route. However, in order to minimize delay, the default behavior should be to start using the route immediately and let higher layers handle possible lost packets, as described below. If a confirmed non-ARP-route-reply arrives later indicating the same destination node, the unconfirmed route entry is replaced regardless of the hop counts of the two routes.

When a node uses an unconfirmed route, there is a risk that the destination node actually is unreachable. The node will not be informed of this via any route failure message. Instead the unfortunate situation will be resolved by other mechanisms. For example, the application initiating the communication can break the connection when it detects that it does not get any response from the remote node. Also, if the packets sent on the unconfirmed route are part of a TCP (Transport Control Protocol) connection, the connection will soon time out and be broken due to a lack of acknowledgements from the remote node. If neither of these two mechanisms apply, the situation will be resolved when the ARP cache entry for the IP address of the destination node expires and this IP address is removed from the ARP cache of the source node. The source node will then try to translate the destination IP address to a MAC address via an ARP-route-request. When this fails, no more packets will be sent on the unconfirmed route. If the ARP-route-request is successful, then the destination node is now reachable and a confirmed route is now established.

In addition to the routing protocol discussed above, the NAL also has a broadcast mechanism. (Note that broadcasting on the LAN is inherent in the shared medium and no “broadcast” mechanism is needed.) In accordance with embodiments of the invention, the NAL includes four different types of broadcasts: NAPSA broadcast, scatternet broadcast, AD broadcast, and scatternet-AD broadcast. The differences between broadcast types lie in the scope of the distribution and how the NAPs and other nodes at the NAPSA borders treat the different broadcast packets. Note that the broadcast type is defined by an indicator in the NAL header. In that sense, these different broadcast types can only exist in the scatternet. On the other hand, an Ethernet broadcast packet (originated on the LAN) that is forwarded from the LAN to the scatternet becomes an AD broadcast packet when it is forwarded into the scatternet. The broadcast type may be indicated in the NAL header, for example, with a two-bit indicator, as indicated in Table 2.

TABLE 2

| Bits | Broadcast Type |
|---|---|
| 00 | NAPSA |
| 01 | Scatternet |
| 10 | AD |
| 11 | Scatternet-AD |

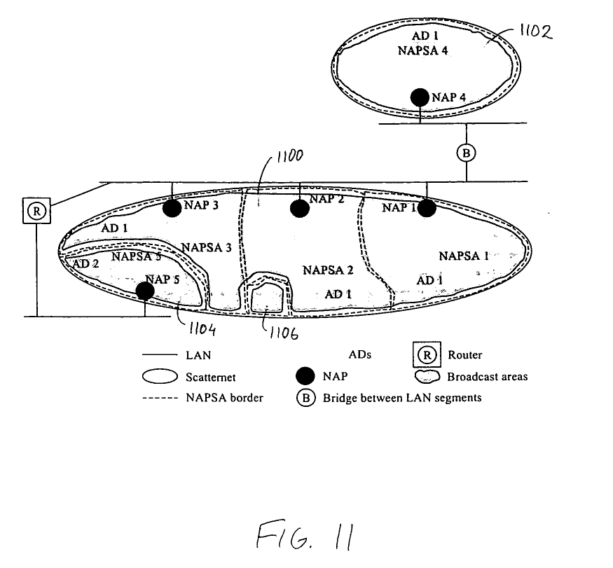

FIGS. 10-15 illustrate the coverage areas of the different broadcast types. The NAPSA broadcast type, as the name implies, is used to broadcast packets to a single NAPSA. This is illustrated in FIG. 10 (which is similar to FIG. 8), where each isolated gray area 1000-1008 represents a different NAPSA broadcast area. A NAPSA broadcast packet is not allowed to leave its broadcast area. Thus, NAPSA broadcast packets are not forwarded to the LAN and are not allowed to cross a NAPSA border.

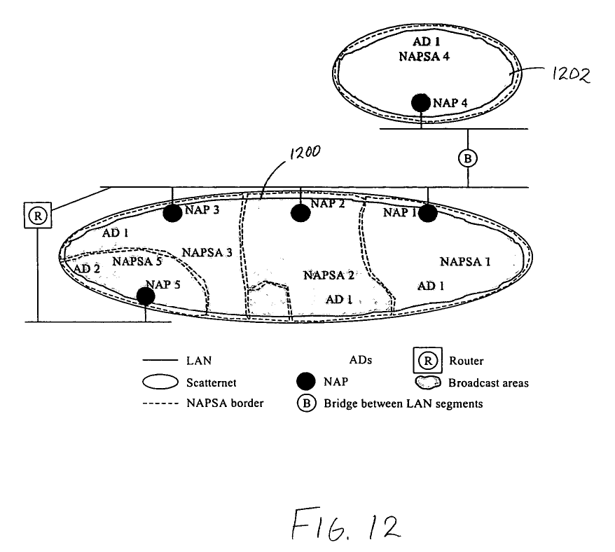

The scatternet broadcast type, as the name implies, is used to broadcast packets within the scatternet. This arrangement is illustrated in FIG. 11, where each contiguous gray area 1100-1106 represents different broadcast areas for a scatternet broadcast packet. Such broadcast packets are not forwarded to the LAN. When more than one AD exists in a scatternet, the scatternet broadcast packets carrying higher layer protocol packets, i.e. packets from protocol layers above the NAL, e.g. IP, are not allowed to cross an AD border. These packets are consequently limited to a part of the scatternet belonging to the same AD. Scatternet broadcast packets that are not carrying packets from higher layer protocols, such as NAL control packets, however, are allowed to cross AD borders and may therefore still be broadcast in the whole scatternet. A NAL control packet does not encapsulate data from a higher protocol layer and is only used to transfer signaling and control information between NAL entities in different Bluetooth nodes. This arrangement is illustrated in FIG. 12, where each contiguous gray area 1200 and 1202 represents the broadcast area of an NAL control packet.

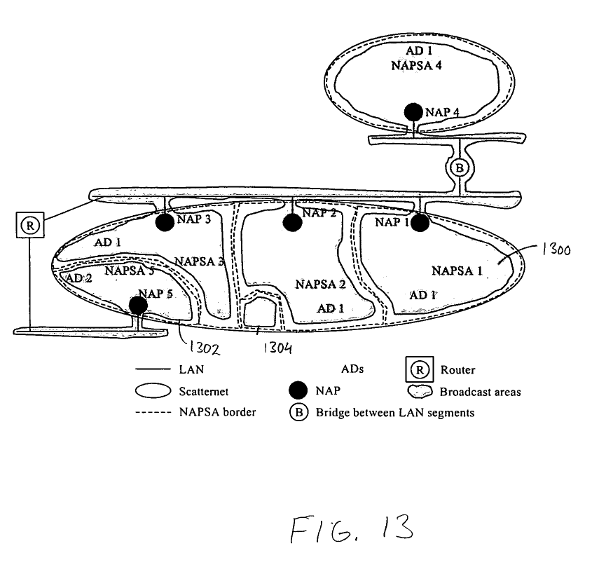

The AD broadcast type covers the LAN and any attached scatternets that are associated with the same AD as the LAN. These broadcast packets are forwarded by NAPs from/to the LAN to/from the scatternet, but the NAPSA borders in the scatternet are respected. This arrangement is illustrated in FIG. 13, where each contiguous gray area 1300-1304 represents the broadcast area of an AD broadcast packet. An AD broadcast packet is used to reach all the nodes in the AD (including the nodes on the LAN). All broadcast packets that are forwarded from the LAN to the scatternet are sent using the AD broadcast type.

The scatternet-AD broadcast type is a special broadcast type used only for route requests. This broadcast type is, as the name implies, a combination of the scatternet broadcast type and the AD broadcast type. The scatternet-AD broadcast packets are distributed through the entire scatternet without respecting the NAPSA borders, as well as the entire AD via the NAPs. However, the NAPSA borders are respected after a scatternet-AD broadcast packet re-enters the scatternet via a NAP.

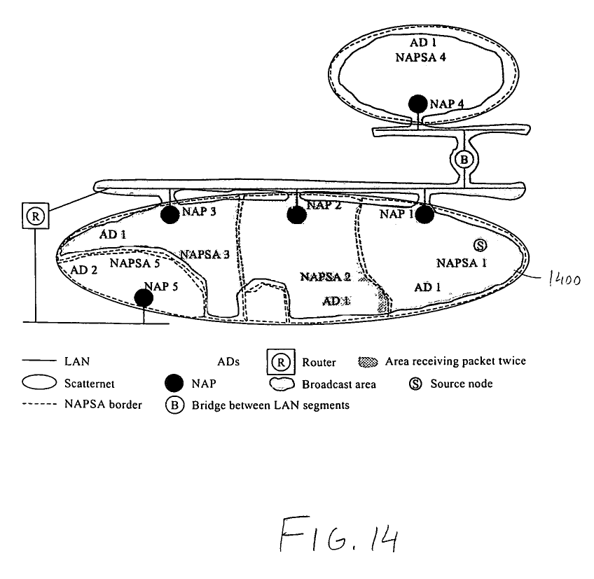

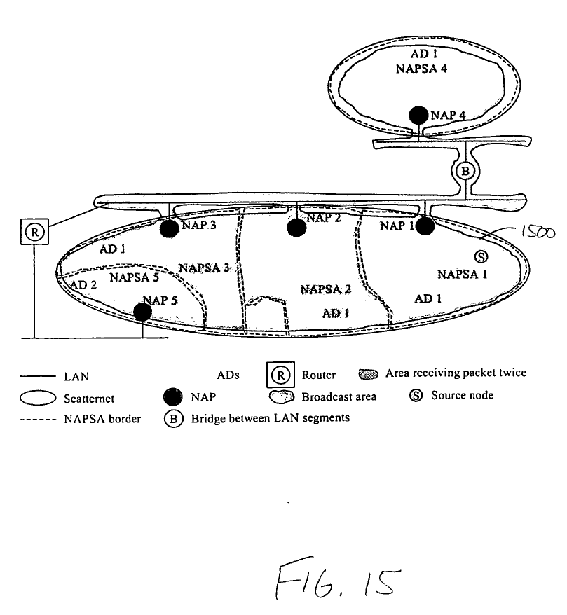

A scatternet-AD packet carrying an ARP-route-request, however, is restricted to a single AD. This arrangement is illustrated in FIG. 14, where each contiguous gray area 1400 represents the broadcast area of a scatternet-AD broadcast packet carrying an ARP-route-request. Note in FIG. 14 that the source node has been labeled with an ‘S,’ representing the source from which the scatternet-AD broadcast packets originated. A scatternet-AD packet carrying a regular route request (non-ARP-route-request) is not limited to a single AD. This arrangement is illustrated in FIG. 15, where the contiguous gray area 1500 represents the broadcast area of a scatternet-AD packet carrying a non-ARP-route-request.

Recall that an AD broadcast packet from the scatternet would be forwarded to the LAN via a single NAP only, namely, the NAP of the NAPSA of the source node 1402. A scatternet-AD broadcast packet, on the other hand, could potentially be forwarded by all the NAPs that are in the same AD as the source node. Therefore, to prevent every NAP from forwarding its packets to the LAN, a change-of-broadcast-type function is implemented in the broadcast emulation mechanism of the NAL. This function changes a scatternet-AD broadcast packet into a scatternet broadcast packet as soon as the packet is received across a NAPSA border. Because scatternet broadcast packets always remain within the scatternet, the NAPs will not forward these packets to the LAN. Due to the change-of-broadcast-type function, only the NAP that is in the same NAPSA as the source node 1402 will forward the packet to the LAN (the packet is still a scatternet-AD broadcast packet in this NAPSA).

When forwarding a scatternet-AD packet to the LAN, the NAP changes the packet to a regular Ethernet broadcast packet. The Ethernet broadcast packet is of course distributed in the entire LAN and, if not blocked by a packet filtering function, forwarded to the other NAPSAs in the scatternet via the other NAPs, just like any broadcast packet on the LAN. Since the Ethernet broadcast packet is indistinguishable from a native LAN Ethernet broadcast packet, the AD broadcast type will be used when the packet is forwarded to the scatternet. Thus, a scatternet-AD broadcast packet will retain its broadcast type only within the NAPSA of the source node. Outside the NAPSA of the source node, the scatternet-AD broadcast packet is changed into either a scatternet broadcast packet (when distributed through the scatternet) or an AD broadcast packet (when distributed via the LAN).

Note in FIG. 14 that some nodes will actually receive the packet twice (area indicated by the dot pattern), once via the scatternet, and again via the LAN (through the NAPs). This is the case for nodes that are connected to the same scatternet as the source node, but belong to different NAPSAs in the same AD. The dual path makes the scatternet-AD broadcast type particularly suitable for sending route requests to find the best route. However, the broadcast types will be different for the two received packets as discussed above. The packet sequence number (described below) will also be different, since the NAP assigns its own sequence number to the broadcast packets it forwards to the scatternet.

In a broadcast emulation network like a Bluetooth scatternet, broadcast loops can occur due to the fact that the emulated broadcast medium actually comprises independent nodes connected to each other via point-to-point links. In other words, there is no high level control or management of the data traffic within the scatternet. In addition, if the scatternet is connected to a LAN via multiple NAPs, broadcast loops can also occur due to the physical loop created between the scatternet, the LAN, and the NAPs. For example, referring back to FIG. 8, an infinite loop will be formed if a broadcast packet is passed from the scatternet via NAP 1 to the LAN 802, and then back into the scatternet 810 via NAP 2, and then to the LAN 802 again via NAP I, and so on. Such loops waste both radio resources and processing resources.

Broadcast loops in the scatternet can be avoided by using sequence numbers generated by the source node for each broadcast packet. The combination of sequence number, source address, and broadcast type makes each broadcast packet unique, and makes it possible for nodes that receive a broadcast packet to determine whether they have already processed that packet. In a stand-alone scatternet the source address and the sequence number would be adequate to make the packet unique, but for reasons explained below, when the scatternet is connected to a LAN via multiple NAPs, the broadcast type has to be added in order to make the data combination unique.

When receiving a broadcast packet, a node first checks whether it already has stored the packet's combination of source address, sequence number and broadcast type, as an indication of a recently processed broadcast packet. If so, the node discards the broadcast packet. Otherwise the node stores the source address, sequence number and broadcast type of the received broadcast packet and processes the packet (which includes forwarding if necessary). The unique data combination for the packet is only stored for a certain limited time period. This time period must be longer than the broadcast packets maximum possible life-time in the network.

Two scenarios are contemplated for generating the sequence numbers when a NAP forwards a broadcast packet to the scatternet. When a NAP forwards to the scatternet a broadcast packet that has not been transferred using the INAPP encapsulation mechanism (described later herein), the NAP generates its own sequence number. The NAP includes the sequence number in the NAL broadcast packet header when it converts the Ethernet broadcast packet to a NAL broadcast packet. However, when a NAL broadcast packet has been transferred using the INAPP encapsulation mechanism, the original sequence number is kept along with the entire NAL header.

The problem of broadcast loops via the LAN only affects the scatternet-AD broadcast type. NAPSA broadcast packets and scatternet broadcast packets cannot form broadcast loops involving the LAN, since they are never forwarded to the LAN via the NAPs. And, since AD broadcast packets are not allowed to cross a NAPSA border in the LAN, broadcast loops involving the LAN cannot occur for AD broadcast packets either.

For the scatternet-AD broadcast type, the situation is different (note that route requests are the only packets sent using the scatternet-AD broadcast type). When a scatternet-AD type broadcast packet leaves the NAPSA of its source node, it is changed into a scatternet type broadcast packet. When a broadcast packet re-enters the scatternet from the LAN, it is always forwarded as an AD type broadcast packet. Neither broadcast types will be able to form loops (as already explained). Hence, the situation that needs to be analyzed is when a broadcast packet is propagated through the scatternet as a scatternet type broadcast packet, and the same broadcast packet is sent into the scatternet from one or several NAPs using an AD type broadcast packet. All nodes that are in the same scatternet and AD as the source node, but in different NAPSAs, will receive the broadcast packet twice. Thus, the broadcast type is needed in addition to the source address and the sequence number in the broadcast packet data combination in order to make it unique.

When broadcast route requests are transferred across the LAN, they are transferred using the INAPP encapsulation mechanism. The INAPP encapsulation mechanism leaves the NAL packet header including the broadcast sequence numbers unchanged. Therefore, the sequence numbers will be the same in the two received packets. However, the difference in broadcast type makes the two received broadcast packets different, so that the last one received is not discarded. Hence, the node will process one broadcast packet received from the source node via the scatternet and one broadcast packet (including the same message) received from the source node via the LAN. This is the intention of the scatternet-AD broadcast type, since a node (in another NAPSA, but in the same scatternet and AD as the source node) should be able to receive and process one route request via the scatternet and one via the LAN. This allows a route to be established along both of these paths so that the source node can pick the best route, i.e., either the route via the LAN or the route through the scatternet, depending on which route has the lowest hop count.

When a source node and a destination node are located in the same scatternet and the same AD, but in different NAPSAs, there are two ways to establish a route between the two nodes: through the scatternet (“intra-scatternet”) or via the LAN (“transit-LAN”). Using the scatternet-AD broadcast type for the route request, both these routes can be established. The source node will start using the route that is established first. If another route reply is received later that has a lower hop count, the source node will replace the previous route entry with the new route and start using the new route. Otherwise the source node keeps the old route entry and discards the new route reply. When the hop count is accumulated, the path across the LAN between the two NAPs is considered as zero hops, due to the superior capacity of the LAN compared to that of the scatternet.

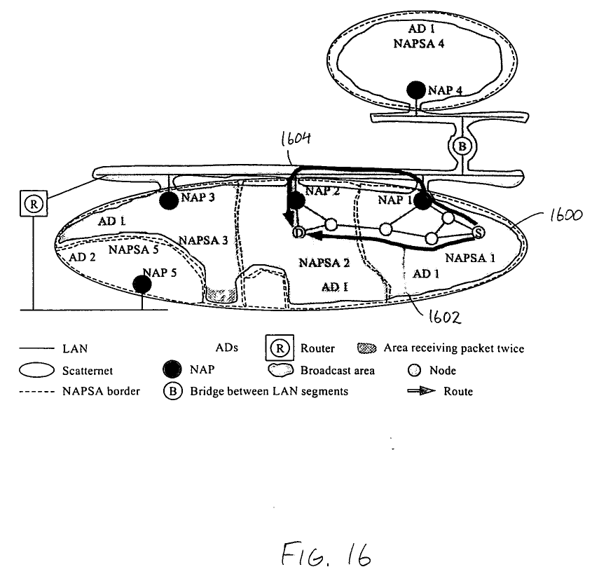

The above scenario is illustrated in FIG. 16, where the source node of the route request is labeled with an ‘S’ and the destination node is labeled with a ‘D’. The broadcast area 1600 is the entire shaded area. The source node S resides in the area covered by NAPSA 1. The areas covered by NAPSA 2 and NAPSA 3 are areas that will receive the route request twice (indicated by the dot pattern), once through the scatternet and once through the LAN via the NAPs. As can be seen, the route 1602 through the scatternet has a hop count of four, while the route 1604 via the LAN has a hop count of three, since the path across the LAN is counted as zero hops. Hence, the route 1604 via the LAN will be selected in this scenario.

As previously explained, a source node may receive multiple route replies even when there are no NAPs involved, e.g., in a stand-alone scatternet. The reason is that each node that has a route to the destination node (indicated in a received route request) may return a route reply to the source node. Since many nodes may have a route to the indicated destination node, a source node may receive many route replies for the same route request.

Following is a more detailed description of the four components briefly introduced earlier.

Packet Conversion and Forwarding

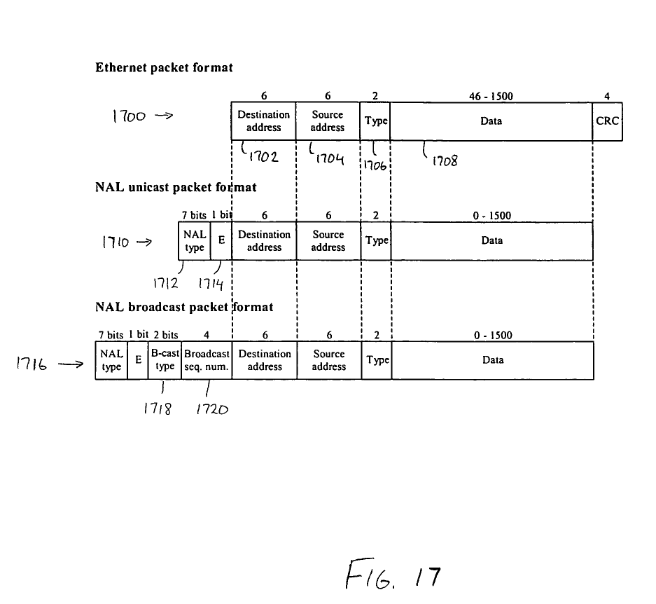

The first main component of the invention is the packet conversion 928 and forwarding 930 mechanisms. This component resides in the NAP-B 904 of the NAP 900 (see FIG. 9). Before forwarding a packet from the scatternet to the LAN or vice versa, the conversion mechanism of the NAP converts the packets between the Ethernet format and NAL packet format. This is a simple procedure, since the NAL packet format has been designed more or less for this purpose and is similar to the Ethernet packet format. An example of each packet format is illustrated in FIG. 17. First of all, NAL packets and Ethernet packets use the same type of addresses for the source and destination addresses in the headers, i.e., 48-bit IEEE 802 MAC addresses. In Bluetooth, these addresses are referred to as BD_ADDRs. Secondly, the MTU (Maximum Transfer Unit) size of a NAL packet corresponds to the MTU size of an Ethernet packet, namely 1500 bytes. The former ensures that no address conversion is needed and the latter ensures that segmentation and re-assembly does not have to be used when converting between the two packet formats.

As can be seen in FIG. 17, the Ethernet format 1700 includes a destination address field 1702, a source address field 1704, a packet type field 1706, and a data field 1708. The NAL unicast packet format 1710 has the same fields as the Ethernet packet format 1700, and also includes a NAL type field 1712, and an optional header extension field ‘E’ 1714. The NAL broadcast packet format 1716 also has the same fields as the NAL unicast packet format 1710, and further includes a broadcast type field 1718 and a broadcast sequence number field 1720.

As for the forwarding mechanism, forwarding packets between the scatternet and the LAN, and vice versa, is the main purpose of a NAP. In general, if a packet reaches the packet forwarding mechanism of the NAP-B, it means the packet has already passed one of the packet filtering functions and was not discarded. In some cases, the packet may still be discarded by the NAP-B even after the packet has reached the NAP-B for reasons related to the NAL routing protocol. Discarded packets, of course, will never be forwarded. Furthermore, all packets that are addressed to the NAP itself are passed directly to the internal packet handling function (NAP-IPH) by the packet filtering function. Thus, these packet also never reach the NAP-B to be forwarded. A general rule when the forwarding mechanism in the NAP-B forwards a packet is that it does not change the source address of the packet that it forwards.

To better appreciate how the NAP-B forwards a packet, it is helpful to understand how routes are established. In general, there are two ways to establish a route: (a) route establishment initiated from the LAN, and (b) route establishment initiated from the scatternet.

For route establishment initiated from the LAN, the route request received by the NAP from the LAN is an ARP request. The NAP converts the ARP request to an ARP-route-request before forwarding it to the scatternet as an AD broadcast type packet. Note that since the ARP request was initiated on the LAN, all LAN nodes have already received this ARP request. The LAN is then indicated as next hop node in the NAP's route entry for the source node. When (and if) an ARP-route-reply is returned to the NAP from the scatternet, the reply is converted into an ARP reply and forwarded to the LAN. In this manner, the route is established. If no ARP-route-reply is received, no route is established and nothing is forwarded to the LAN.

In addition to the ARP-route-reply, the NAP may also receive a broadcast ARP reply from the scatternet in response to the ARP-route-request. The NAP would receive a broadcast ARP reply from the scatternet if the ARP-route-request concerns a link-local IP address. In that case, the target/destination node in the scatternet will respond first with a unicast ARP-route-reply, then with a broadcast ARP reply. The broadcast ARP reply is sent because it is mandated by the Internet-Draft on autoconfiguration of link-local addresses that an ARP reply concerning a link-local IP address should be broadcast instead of unicast in order to facilitate detection of duplicate addresses (which may occur during autoconfiguration). In the case of an ARP-route-request concerning a link-local IP address, the response should not be only a broadcast ARP reply, since that will not establish a route. Therefore a unicast ARP-route-reply is sent to establish a route (and convey the MAC address to the source node), and a broadcast ARP reply is broadcast to facilitate duplicate address detection as stipulated by the Internet-Draft. Upon receipt by the NAP, the broadcast ARP reply is forwarded to the LAN as a broadcast ARP reply. Similarly, the unicast ARP-route-reply is converted into an ARP reply and forwarded to the LAN.

In some cases, the NAP may receive a unicast packet from the LAN without a preceding ARP request. A unicast packet is basically any Ethernet packet with a unicast address as the destination address; most unicast packets will have an encapsulated IP packet. When this happens, the NAP forwards the unicast packet to the destination node along an existing route, if one is available. Otherwise, the NAP sends a regular route request (non-ARP-route-request) into the scatternet using the AD broadcast type in order to establish a route along which the unicast packet can then be sent. Like any node would do when forwarding a route request, the NAP creates a temporary route entry for the source node, and indicates the next hop node therein as the LAN (unless the NAP already has a route entry for the source node). The NAP also starts a route reply timer at the value routeReplyTimeoutPeriod. When (and if) a regular route reply (non-ARP-route-reply) is received in response to the regular route request, the route to the destination node is established. However, instead of forwarding the received regular route reply (non-ARP-route reply) to the LAN, it is used only to send the unicast packet to the destination. If no non-ARP-route-reply is received before the route reply timer expires, no route is established, and the unicast packet is discarded.

As for route establishment initiated from the scatternet, the routes can be initiated in the following ways: (1) route establishment initiated using an ARP-route-request, and (2) route establishment initiated using a non-ARP-route-request. For route establishment initiated using an ARP-route-request, when the NAP-B receives an ARP-route-request from the scatternet (via the NAP-PFS), it creates a temporary route entry for the source node (unless it already has a route entry for the source node). The NAP-B then attempts to establish a route to the destination node. If successful, the resulting route may be of two distinctly different kinds: (i) a route continuing through another NAP to terminate in another scatternet, or in the same scatternet as the source node, but in another NAPSA (i.e., a “transit-LAN route”), and (ii) a route terminating on the LAN (which in practice means that the last node maintaining a route entry for the route will be the NAP, since LAN nodes do not use the NAL routing protocol).

Since the NAP-B does not know whether the destination is a LAN node or a scatternet node, it will try to accommodate both cases. To accommodate the first case, i.e., the transit-LAN route case, the NAP-B of the NAP forwards the ARP-route-request to the LAN using the INAPP encapsulation mechanism (i.e., encapsulated in an INAPP message as described later herein). The encapsulated ARP-route-request can only be received by other NAPs on the LAN, since only NAPs will recognize the protocol type, i.e. INAPP, indicated in the Ethernet header. Other nodes will just discard the packet.

To accommodate the second case (i.e., the destination node being a LAN node), the NAP-B extracts the ARP request from the ARP-route-request and sends it on the LAN after the encapsulated ARP-route-request has been sent. Then, in order to be able to distinguish a desired ARP reply from other ARP replies (there may be several pending ARP requests for which the NAP has not yet received an ARP reply), the NAP-B stores the “target IP address” (i.e., the IP address of the destination node) and the “sender MAC address” (i.e., the MAC address of the node sending the ARP-route-request) of the ARP request. The addresses are stored in a table for pending ARP requests triggered by route requests from the scatternet. The stored source MAC address also serves as a pointer to the specific route entry to be used for sending a possible ARP-route-reply to the source node. Table 3 below is an example of a table for pending ARP requests triggered by route requests from the scatternet.

TABLE 3

| Target IP Address | Source MAC Address | Timer |
|---|---|---|
| IP address 1 | MAC address 1 | Entry 1 timer |
| IP address 2 | MAC address 2 | Entry 2 timer |
| IP address 3 | MAC address 3 | Entry 3 timer |
| ... | ... | ... |
| IP address 7 | MAC address 7 | Entry 7 timer |

As can be seen, each IP address has a corresponding MAC address. A timer entry governs the lifetime of each address entry in the table. The timer for an address entry is started when the entry is stored and when the timer expires, the entry is removed from the table. The resulting timeout period should preferably be the same as for a temporary route entry, i.e., the timer should be started at the value shortInterval.

As mentioned previously, an encapsulated ARP-route-request can only be received by the NAPs. The NAPs can also receive an ARP request (as can any node on the LAN). Hence, a receiving NAP has to be able to handle reception of both an encapsulated ARP-route-request and a regular ARP request from the same source (via the forwarding NAP) to the same destination. Preferably the receiving NAP should not generate and send two ARP-route-requests in the scatternet, since this would be a waste of resources. Neither should it send both an encapsulated ARP-route-reply and a regular ARP reply on the LAN (although this would be less damaging from a resource point of view, since the capacity of the LAN is so much greater than that of the scatternet).

In accordance with embodiments of the invention, the encapsulated ARP-route-request and the regular ARP request both have the same target IP address and the same source MAC address. When the NAP-B of a NAP receives the encapsulated ARP-route-request, it forwards the ARP-route-request to the scatternet and indicates the next hop node in the route entry for the source node as “another NAP.” (If the receiving NAP is itself the destination node, then it sends an encapsulated ARP-route-reply to the LAN.) This indication may be just a general indication, or it may be specific indication. A specific indication includes an NAP multicast address or the specific source MAC address of the Ethernet packet that carried the received encapsulated ARP-route-request. The choice between an NAP multicast address or a MAC address depends on whether broadcast packets, multicast packets or unicast packets are used to carry the corresponding encapsulated ARP-route-reply. The NAP-B also stores the target IP address and the source MAC address of the recently received encapsulated ARP-route-request. The addresses are stored to enable the NAP-B to identify the subsequently arriving ARP request, so that the NAP-B can avoid sending a second, redundant ARP-route-request into the scatternet.

The target IP address and the source MAC address of the encapsulated ARP-route-request are stored in a table for recently received encapsulated ARP-route-requests. Table 4 below is an example of a table for pending ARP-route-requests triggered by encapsulated ARP-route-requests.

TABLE 4

| Target IP Address | Source MAC Address | Timer |
|---|---|---|
| IP address 1 | MAC address 1 | Entry 1 timer |
| IP address 2 | MAC address 2 | Entry 2 timer |
| IP address 3 | MAC address 3 | Entry 3 timer |
| ... | ... | ... |
| IP address 7 | MAC address 7 | Entry 7 timer |

The information stored in Table 4 is similar to the information stored in Table 3 in that each IP address has a corresponding MAC address. The lifetime of each entry in the table is governed by a timer. The timer for an entry is started when the entry is stored and when the timer expires, the entry is removed from the table. The resulting timeout period should preferably be the same as for a temporary route entry, i.e., the timer should be started at the value shortInterval.

When a regular ARP request is received, the NAP-B checks its table (Table 4) for recently received encapsulated ARP-route-requests to find out whether it would be redundant to forward the ARP request. If the target IP address and the source MAC address of the ARP request are found in the table (which should be the case during transit-LAN route establishment), the ARP request is not forwarded. Otherwise the ARP request is converted into an ARP-route-request and forwarded as described above.

When (and if) an ARP-route-reply is received from the scatternet, the NAP-B forwards it to the LAN as an encapsulated ARP-route-reply. If no ARP-route-reply is received, no route is established and nothing is forwarded to the LAN.

In addition to receiving the ARP-route-reply from the scatternet (via the NAP-PFS), the NAP-B may also receive a broadcast ARP reply (directly from the scatternet) in response to the same ARP-route-request. In that case, the broadcast ARP reply is forwarded to the LAN as a broadcast ARP reply.

The first NAP, i.e., the NAP that sent the encapsulated ARP-route-request and the regular ARP request, will wait for replies to either of the messages. If the destination node is located on the LAN, the NAP can expect to receive a single reply (a unicast ARP reply or a broadcast ARP reply). Note that on a shared medium LAN, unicast means that a unicast MAC address is the destination address of the packet. However, all the nodes on the LAN will receive the packet, since the LAN is a shared medium. It is up to the interface card of each node to discard packets that the node is not supposed to receive. If the destination node is located in a scatternet, the NAP can expect to receive one encapsulated ARP-route-reply and possibly also one broadcast ARP reply from the same responding node (both forwarded to the LAN by the second NAP).

If an encapsulated ARP-route-reply is received, the NAP-B of the first NAP checks whether the “sender IP address” and the “target MAC address” matches the target IP address and the source MAC address of any entry in the table (Table 3) for pending ARP requests triggered by route requests from the scatternet. If a matching entry is found, the NAP-B forwards the ARP-route-reply to the source node that sent the original ARP-route-request (which is the destination node of the ARP-route-reply). In this way, a route is established. The entry is then removed, irrespective of the value of the entry's timer. Thus, any subsequent broadcast (or unicast) ARP reply received by the NAP-B can not be matched with an entry in the table for pending ARP requests triggered by route requests. Consequently, such a subsequent broadcast (or unicast) ARP reply would simply be forwarded to the scatternet as a broadcast (or unicast) ARP reply.

If, instead of the encapsulated ARP-route-reply, an ARP reply (either unicast or broadcast) is received from the LAN (via the NAP-PFL) in the first NAP, the NAP-B checks whether the “sender IP address” and the “target MAC address” of the ARP reply matches the target IP address and the source MAC address of any entry in the table (Table 3) for pending ARP requests triggered by route requests from the scatternet. If no matching entry is found, the packet is treated just like any ARP reply, i.e., it is forwarded to the scatternet as a (unicast or broadcast) ARP reply. If, on the other hand, a matching entry is found in the table, the ARP reply is converted to an ARP-route-reply and forwarded to the source node of the original ARP-route-request in the scatternet using the route entry indicated by the source MAC address in the matching table entry. The hop count stored in the first NAP's route entry for the source node is included in the ARP-route-reply. In this way, the route is established. Then, the matching table entry is removed from the table (irrespective of the value of the entry's timer).

If the received ARP reply was a broadcast ARP reply, it is also forwarded to the scatternet as a broadcast ARP reply in addition to being sent as an ARP-route-reply.

If the NAP-B in the first NAP does not receive any reply at all before the entry in the table for pending ARP requests (triggered by route requests from the scatternet) times out, the NAP does not forward anything to the scatternet and no route is established.

It should be noted that the combined behavior of the two involved NAPs will in certain rare situations result in suboptimal routes. Such a contingency may be illustrated by referring again to FIG. 16. The source node S located in NAPSA 1 sends an ARP-route-request in order to find the MAC address and a route to the destination node D, which is located in NAPSA 2. Node D receives the ARP-route-request through both the scatternet and the LAN (via NAP 1 and NAP 2). If node D, in response to the ARP-route-request received via the LAN, sends a broadcast ARP reply in addition to an ARP-route-reply, there is a slight possibility that the broadcast ARP reply will reach NAP 2 before the ARP-route-reply does, even though the broadcast ARP reply, as stated earlier, must be sent after the ARP-route-reply is sent. This kind of rearrangement of packet order can sometimes happen in a packet oriented network. NAP 2 will then forward the broadcast ARP reply to the LAN and it will be received by NAP 1, which is waiting for a reply to the pending ARP-route-request from source node S. When the broadcast ARP reply is received by NAP 1, NAP 1 will generate an ARP-route-reply and send it to S. The problem is that this ARP-route-reply will indicate an incorrect hop count, namely the hop count between NAP 1 and source node S instead of the hop count between destination node D and source node S via the LAN. The subsequent encapsulated ARP-route-reply will also be forwarded by NAP 1, but since this ARP-route-reply will indicate a greater (although correct) hop count than the first ARP-route-reply, it will be discarded by node S.

Now if the real hop count of the route via the LAN is smaller than the hop count of the route via the scatternet, the incorrect hop count indication in the ARP-route-reply received from NAP 1 has caused little harm, since even with a correct hop count indication, node S would have chosen the route via the LAN. However, if the incorrect hop count indication indicates a hop count that is smaller than the hop count of the route through the scatternet, while the real hop count of the route via the LAN is actually greater than the hop count of the route through the scatternet, then the incorrect hop count indication will cause node S to incorrectly choose the route via the LAN as the best route.

If a NAP receiving an ARP-route-request knows that the destination node is a Bluetooth node in another scatternet or in the same scatternet but in another NAPSA, it may skip sending the regular ARP request into the LAN. It would then send only the encapsulated ARP-route-request into the LAN directed to other NAP(s), which can forward the request to the destination node. Likewise, if a NAP receiving an ARP-route-request knows that the destination node is an Ethernet node located on the LAN, it may skip sending the encapsulated ARP-route-request. It would then send only the regular ARP request into the LAN. As explained earlier (and later in more detail), this information is possibly available in the address table (in the common packet filtering function) of a NAP. In order to extract the information, the NAP first has to use its ARP cache to translate the target IP address of the ARP-route-request into the corresponding MAC address, provided that the target IP address can be found in the ARP cache.

As for route establishment initiated using a non-ARP-route-request, this method is used when a source node wants to send a packet to a destination node, the IP address for which is included in the source node's ARP cache, but for which the source node does not have a route. Such a missing route may occur for any destination node, since the ARP cache is constantly updated by all the ARP packets (both requests and replies) that the source node receives. It may also happen because a source node wants to send packets to a destination node with which the source node has communicated before and which is still included in the ARP cache, but for which the route has broken or timed out.

If the NAP already has a route entry for the destination node, or if the NAP itself is the destination node, it will send a non-ARP-route-reply to the source node. Otherwise the procedure proceeds as follows.

Since the NAP does not know the IP address of the destination node, it cannot convert the non-ARP-route-request into an ARP request. Therefore the NAP will send an encapsulated non-ARP-route-request only to cover the case when the destination node is a scatternet node. However, rather than waiting for a non-ARP-route-reply (which may not arrive because the destination node may be located on the LAN instead, or it may be missing altogether), the NAP sends an unconfirmed proxy non-ARP-route-reply, including the hop count accumulated by the received non-ARP-route-request, to the source node in the scatternet to cover the case when the destination node is a LAN node. An unconfirmed proxy non-ARP-route-reply is (as was explained previously) a non-ARP-route-reply with an indication that the route has not been confirmed by the destination node or a node with a route to the destination node. In this way, an unconfirmed route has been established.

When (and if) the NAP-B of a NAP receives an encapsulated non-ARP-route-request (via the NAP-PFL), the NAP processes the non-ARP-route-request just like any node would process a received non-ARP-route-request. Thus, the NAP forwards the non-ARP-route-request into the scatternet, unless it already has a route to the destination node, or unless the NAP itself is the destination node. In the latter case, the NAP can immediately return an encapsulated non-ARP-route-reply. Then the next hop node in the route entry for the source node is indicated as “another NAP.” This indication may be just a general indication, or it may be a specific indication that includes a NAP multicast address or the specific source MAC address of the Ethernet packet that carried the received encapsulated ARP-route-request. The choice between general indication, NAP multicast address or source MAC address depends on whether broadcast packets, multicast packets or unicast packets are used to carry a corresponding encapsulated ARP-route-reply.

When (and if) a non-ARP-route-reply is received from the scatternet, the NAP forwards it as an encapsulated non-ARP-route-reply. If no non-ARP-route-reply is received, nothing is forwarded to the LAN and no confirmed route is established.

If the NAP that sent the encapsulated non-ARP-route-request receives an encapsulated non-ARP-route-reply, this means the route is now confirmed. The NAP will then discard the unconfirmed route entry and replace it with the confirmed route entry. The NAP then forwards the non-ARP-route-reply to the source node in the scatternet, and the source node replaces the unconfirmed route with the confirmed route (unless a route with a better hop count than the transit-LAN route has been established through the scatternet). In this way, a confirmed route has been established. If no encapsulated non-ARP-route-reply is received, the NAP keeps the unconfirmed route and uses it for routing of subsequent packets (unless the unconfirmed route is replaced in the source node by a route through the scatternet).

If a NAP receiving a non-ARP-route-request from the scatternet knows that the destination node is a Bluetooth node in another scatternet or in the same scatternet but in another NAPSA, it may skip sending the unconfirmed proxy non-ARP-route-reply. It would then send only the encapsulated non-ARP-route-request. Likewise, if a NAP receiving a non-ARP-route-request knows that the destination node is an Ethernet node located on the LAN, it may skip sending the encapsulated non-ARP-route-request. It would then send only the unconfirmed proxy non-ARP-route-reply. How this information might be available in the address table (in the common packet filtering function) of a NAP will be explained later herein.

With the above explanation of how routes are established, a discussion of how the bridging function (NAP-B) forwards packets is in order. Packets that are received by the NAP-B from the scatternet are forwarded to the LAN as follows. When the NAP-B receives an ARP-route-request (via the NAP-PFS), it first forwards the packet as an encapsulated ARP-route-request. It then sends a corresponding ARP request on the LAN, i.e., it forwards the ARP request that was piggybacked on the received route request. The NAP-B then stores the target IP address and the source MAC address of the ARP request in the table (e.g., Table 3) for pending ARP requests triggered by route requests from the scatternet and starts the associated timer at the value shortInterval. The NAP-B also passes the ARP request to the NAP-IPH.

When the NAP-B receives a non-ARP-route-request from the NAP-PFS, it first forwards the packet as an encapsulated non-ARP-route-request. It then sends an unconfirmed proxy non-ARP-route-reply to the source node and creates an unconfirmed route entry (i.e., a route entry with an indication that the route entry is unconfirmed) for the destination node. The next hop node in the unconfirmed route entry is indicated as “the LAN.” The route entry timer for the unconfirmed route entry is started at the value longInterval.

When the NAP-B receives an ARP-route-reply from the NAP-PFS, it checks whether the next hop node in the route entry of the source node of the original ARP-route-request (i.e., the destination node of the ARP-route-reply) is indicated as “the LAN” or as “another NAP” (or any variants thereof). If the next hop node is indicated as “the LAN,” the ARP request is converted into an ARP reply and forwarded to the LAN. If the next hop node is indicated as “another NAP”, the NAP-B forwards the ARP-route-reply to the LAN as an encapsulated ARP-route-reply.

When the NAP-B receives a non-ARP-route-reply from the NAP-PFS, it can handle the situation in two different ways depending on how the preceding non-ARP-route-request was triggered. If the preceding non-ARP-route-request from the NAP was triggered by an encapsulated non-ARP-route-request received from another NAP on the LAN, the non-ARP-route-reply is forwarded to the LAN as an encapsulated non-ARP-route-reply. If the preceding non-ARP-route-request was triggered by a unicast packet received from a node on the LAN, the non-ARP-route-reply is not forwarded to the LAN. The reason, as will be explained in more detail later herein, is that the non-ARP-route-request that the NAP sent into the scatternet was not triggered by an encapsulated route request or an ARP request from the LAN, so there is no request to reply to on the LAN. Instead the non-ARP-route-request was sent by the NAP in order to get a route to the destination node indicated in the unicast packet that was received from the LAN.

When the NAP-B receives an ARP request from the NAP-PFS, it simply forwards it to the LAN as an ARP request. The NAP-B also passes the ARP request to the NAP-IPH.

When the NAP-B receives a general unicast packet from the NAP-PFS, it simply forwards the packet to the LAN as a unicast packet. The term “general unicast packets” refers to unicast packets other than ARP replies and route replies.

On the other hand, unicast ARP replies received by the NAP-B from the NAP-PFS are treated like general unicast packets, i.e., they are simply forwarded to the LAN as unicast ARP replies.

When a general broadcast packet is received by the NAP-B from the NAP-PFS, it is simply forwarded to the LAN as a broadcast packet. The term “general broadcast packets” refers to broadcast packets other than ARP requests, route requests, and broadcast ARP replies. This includes, among other packet types, ARP probes and gratuitous ARP requests. (See, e.g., IEFT draft: Stuart Chesire and Bernard Aboba, “Dynamic Configuration of IPv4 Link-Local Addresses.”) The NAP-B also passes the broadcast packet to the NAP-IPH.

When the NAP-B receives a broadcast ARP reply from the NAP-PFS, it is treated like a general broadcast packet, i.e., it is simply forwarded to the LAN as a broadcast ARP reply. The NAP-B also passes the broadcast ARP reply to the NAP-IPH.

As for packets received by the NAP-B from the LAN, these packets are forwarded to the scatternet as follows. When the NAP-B receives an encapsulated ARP-route-request from the NAP-PFL, it forwards the ARP-route-request to the scatternet and indicates the next hop node as “another NAP” in the route entry for the source node. This indication may be just a general indication, or it may be a specific indication that includes an NAP multicast address or the specific source MAC address of the Ethernet packet that carried the received encapsulated ARP-route-request. The choice between general indication, NAP multicast address or the specific source MAC address depends on whether broadcast packets, multicast packets or unicast packets are used to carry a corresponding encapsulated ARP-route-reply. The NAP-B then stores the target IP address and the source MAC address of the encapsulated ARP-route-request in a table for recently received encapsulated ARP-route-requests. The NAP-B also passes the piggybacked ARP request to the NAP-IPH.

When the NAP-B receives an encapsulated non-ARP-route-request from the NAP-PFL, it checks whether it already has a route entry for the destination node. If this is the case, it sends an encapsulated non-ARP-route-reply to the LAN. Otherwise, it forwards the non-ARP-route-request to the scatternet. In both cases, the NAP-B then indicates the next hop node in the route entry for the source node as “another NAP.” This indication may be just a general indication, or it may be a specific indication that includes an NAP multicast address or the specific source MAC address of the Ethernet packet that carried the received encapsulated ARP-route-request. The choice between general indication, NAP multicast address or the specific source MAC address depends on whether broadcast packets, multicast packets or unicast packets are used to carry a corresponding encapsulated ARP-route-reply.

When the NAP-B receives an encapsulated ARP-route-reply from the NAP-PFL, it first checks whether the sender IP address and the target MAC address of the piggybacked ARP reply matches the target IP address and the source MAC address of any entry in the table (e.g., Table 3) for pending ARP requests triggered by route requests from the scatternet. If a matching entry is found, this entry is removed (irrespective of the value of the entry's timer). Next, the NAP-B forwards the ARP-route-reply to the source node of the original ARP-route-request (which is the destination node of the ARP-route-reply), using the route entry for the source node. The NAP-B also passes the piggybacked ARP reply to the NAP-IPH.

When the NAP-B receives an encapsulated non-ARP-route-reply from the NAP-PFL, it discards the unconfirmed route entry (if any) for the destination node of the original non-ARP-route-request (i.e., the source node of the non-ARP-route-reply), replaces it with the confirmed route entry created by the encapsulated non-ARP-route-reply and forwards the non-ARP-route-reply to the source node in the scatternet.

When the NAP-B receives an ARP request from the NAP-PFL, it checks the table for recently received encapsulated ARP-route-requests to find out whether it would be redundant to forward the ARP request. If the target IP address and the source address of the ARP request are found in the table, the ARP request is not forwarded. Otherwise the ARP request is converted into an ARP-route-request and forwarded to the scatternet and the next hop node in the route entry for the source node is indicated as “the LAN.” The NAP-B also passes the ARP request to the NAP-IPH.

When the NAP-B receives a general unicast packet from the NAP-PFL, it checks whether it has a route entry for the destination node. If yes, the unicast packet is forwarded to the destination node using the existing route. Otherwise a non-ARP-route-request is broadcast in the scatternet in order to establish a route, along which the unicast packet can be sent. The next hop node in the route entry for the source node is indicated as “the LAN” (unless the NAP-B already had a route entry for the source node). The NAP-B also starts a route reply timer at the value routeReplyTimeoutPeriod. When (and if) the non-ARP-route-reply is received, the route is established, but the non-ARP-route reply is not forwarded to the LAN. Then the unicast packet can be sent to the destination using the established route. If no non-ARP-route-reply is received before the route reply timer expires, no route is established and the unicast packet is discarded.

When the NAP-B receives a unicast ARP reply from the NAP-PFL, it checks whether the sender IP address and the target MAC address of the ARP reply matches the target IP address and the source MAC address of any entry in the table for pending ARP requests triggered by route requests from the scatternet. If a matching entry is found in the table, the ARP reply is converted to an ARP-route-reply and forwarded to the source node of the original ARP-route-request in the scatternet using the route entry indicated by the source MAC address in the matching table entry. Then the matching table entry is removed from the table (irrespective of the value of the entry's timer). If no matching entry is found, the packet is treated like a general unicast packet.

When a general broadcast packet is received by the NAP-B of a NAP from the NAP-PFL, it is simply forwarded to the LAN as a broadcast packet. The NAP-B also passes the broadcast packet to the NAP-IPH.

When the NAP-B receives a broadcast ARP reply from the NAP-PFL, it checks whether the sender IP address and the target MAC address of the broadcast ARP reply matches the target IP address and the source MAC address of any entry in the table (e.g., Table 3) for pending ARP requests triggered by route requests from the scatternet. If a matching entry is found in the table, the ARP reply is converted to an ARP-route-reply and forwarded to source node of the original ARP-route-request in the scatternet using the route entry indicated by the source MAC address in the matching table entry. Then the matching table entry is removed from the table (irrespective of the value of the entry's timer). Then the broadcast ARP reply is also forwarded to the scatternet as a broadcast ARP reply (in addition to the ARP-route-reply). If no matching entry is found, the broadcast ARP reply is treated like a general broadcast packet, i.e., the packet is forwarded to the scatternet as a broadcast ARP reply. In both cases the NAP-B also passes the ARP reply to the NAP-IPH.

Packet Filtering

The second main component of the invention is the packet filtering mechanism. As already mentioned, a NAP does not indiscriminately forward packets. Instead, it uses the packet filtering mechanisms (see FIG. 9) to reduce the number of unnecessarily forwarded packets. For example, forwarding is unnecessary when both the source and the destination node are located on the same side of the NAP. Furthermore, NAL broadcast packets of the NAPSA broadcast type and the scatternet broadcast type are always blocked by the packet filtering mechanisms. Only those packets that pass the packet filtering mechanisms are forwarded to the scatternet. The generated useless traffic is a waste of resources, especially so in the scatternet where radio resources and processing resources are scarce. Furthermore, this could lead to the scatternet being flooded by traffic from the LAN with its shared medium and much higher capacity. Therefore, a packet filtering mechanism is needed in order to limit the forwarding of unnecessary traffic. The packet filtering is based on the destination address and the NAL packet type. Filtering may also be based on higher layer protocols.

The NAL packet type filtering in the NAP is performed in the packet type filtering function 912, which is present only on the scatternet side of the NAP. The NAL packet type filtering, in some embodiments of the invention, is very simple: all NAPSA broadcast type and scatternet broadcast type packets are passed by the packet type filtering function 912 to the NAP-IPH, while all other packet types are passed to the address filtering function 914.

Address-based packet filtering relies on a source address learning process similar to the process used by LAN bridges (as described in the IEEE 802.1D standard). A NAP looks at the source address of the packets (Ethernet packets as well as NAL packets) that it receives to learn whether the node associated with the source address is located on the LAN side of the NAP or the scatternet side. On the LAN side, the NAP will look at the source address of all packets, including those that it forwards, those that it does not forward, and those addressed to the NAP itself. On the scatternet side, the NAP will use the same principle, except that it will disregard the source address of scatternet type broadcast packets (and any other future broadcast type that may reach the NAP from another NAPSA).

The collected source addresses are placed in an address table that resides in the common packet filtering functions module 910 of the NAP. Each address in the address table has an indication associated therewith that indicates whether the corresponding node is located on the LAN side (if the address was last received as a source address on the NAP's LAN interface) or the scatternet side (if the address was last received as a source address on the NAP's scatternet interface) of the NAP. It should be noted that only nodes located in the NAP's own NAPSA will be indicated as being on the scatternet side. Nodes located in other NAPSAs will be indicated as being on the LAN side, even if they are connected to the same scatternet as the NAP. This happens because the only way packets can flow between a NAP and a scatternet node in another NAP's NAPSA is via the LAN (except for scatternet broadcast packets, which are disregarded by the source address learning process).

An address is not kept indefinitely in the address table. Unless refreshed by later interceptions of packets with the same source address, an address eventually times out and is removed from the address table after a certain time period, e.g., around 15 minutes.

The address filtering mechanism also utilizes the ARP cache in combination with the address table. The ARP timeout, that is, the time period an entry (i.e., an IP address—MAC address pair) is stored in the ARP cache since it was last refreshed, varies between different devices. For efficient address filtering, a long ARP timeout in a NAP, e.g., in the same range as the timeout used in the address table is preferred.

An optional extension to the address table may be implemented to include additional information for addresses of nodes indicated to be located on the LAN side of the NAP. For each such address, an indication of whether the corresponding node is a scatternet node (i.e., a Bluetooth node), a LAN node (i.e., an Ethernet node), or of unknown type (i.e., either a scatternet or a LAN node) may be included.

The additional information can be made available to a NAP from information in the INAPP messages. For example, an address that appears as the source node in an encapsulated route request or an encapsulated route reply indicates that the source node is located in a scatternet. Furthermore, the INAPP information message explicitly informs the NAP that a certain node is a scatternet node.

If a NAP that has sent an encapsulated ARP-route-request and a regular ARP request receives a unicast ARP reply, this indicates that the destination node (i.e., the responding node) is located on the LAN.

For addresses indicated in the address table as belonging to scatternet nodes, it is also possible to indicate the MAC address of the NAP by which the node can be reached. This could be used to let a NAP unicast an encapsulated route request to the correct NAP instead of broadcasting (or multicasting) it to all NAPs on the LAN.

Following is an explanation of how the address table is used for address-based filtering of different kinds of packets.

General broadcast packets, which include all broadcast packets other than route requests, encapsulated route requests, ARP requests, and broadcast ARP replies, are always passed to the NAP-B by the address filtering function in the NAP. This includes ARP probes and gratuitous ARP requests, which are always passed by the address filtering function to the NAP-B, where they are forwarded to the other side. The only way to make a NAP block an ARP probe or a gratuitous ARP request is to send it using the scatternet broadcast type.

A unicast packet received by the address filtering function (on either side of the NAP) that is not addressed to the NAP itself is passed to the NAP-B, unless the address filtering function determines from the address table that the destination node is located on the receiving side (i.e., the side from which the unicast packet was received). That is, a unicast packet will be passed to the NAP-B, if the address table indicates that the destination node is located on the other side or if the destination address is not included in the address table at all, but not if the address table indicates that the destination node is located on the receiving side.

If a unicast packet received from either the scatternet or the LAN is addressed to the NAP itself, the address filtering function passes the packet to the NAP-IPH. The unicast packet may be any unicast packet, including unicast ARP replies, route replies, encapsulated ARP replies, and general unicast packets.

As for ARP-route-requests, encapsulated ARP-route-requests, and ARP requests received by the address filtering function on either side of the NAP, if such a packet is addressed to the NAP itself, i.e., if its “target IP address” is the NAP's own IP address, the address filtering function passes the packet to the NAP-IPH. Otherwise, since such a packet does not contain a destination MAC address, the address filtering function in the NAP cannot use its address table in the way described above to find out on which side of the NAP the destination node is located. The destination MAC address of the Ethernet packet in which an encapsulated ARP-route-request is encapsulated does not apply in this situation, since that address is not the address of the destination node of the ARP-route-request. However, each of the ARP-route-request, encapsulated ARP-route-request, and ARP request contains a “target IP address,” i.e., the IP address of the destination node. Thus, the address filtering function can utilize the ARP cache to find the MAC address of the destination node, provided that the target IP address is stored in the ARP cache. Once the destination MAC address is retrieved, the condition for passing the packet to the NAP-B is the same as described above for general unicast packets and unicast ARP replies, i.e., the packet will be passed to the NAP-B, unless the address table indicates that the destination node is located on the side of the NAP where the packet was received.

If the destination MAC address cannot be retrieved, the address filtering function has no indication of where the destination node is located. In that case, it will simply pass the packet to the NAP-B.

For non-ARP-route-requests received from the scatternet and encapsulated non-ARP-route-requests received from the LAN, the address filtering function follows the same procedure as described above for general unicast packets and unicast ARP replies. That is, if the packet is addressed to the NAP itself (i.e. the target address of the route request is a MAC address of the NAP), the address filtering function passes the packet to the NAP-IPH. Otherwise, the packet will be passed to the NAP-B, unless the address table indicates that the destination node is located on the side of the NAP where the packet was received (in which case the packet is discarded).

Broadcast ARP replies, including ARP replies containing a link-local sender IP address, are used to facilitate duplicate address detection. If the IP address included in the “sender IP address” field of the ARP reply is being used by another node too, the other node will be able to detect the duplication and react accordingly when it receives the broadcast ARP reply. For this type of packet, the packet filtering mechanism is a trade-off between facilitation of duplicate address detection, requiring that as many broadcast route replies as possible are forwarded, and conservation of the limited resources (e.g., bandwidth, computation power) in the scatternet.

On the LAN, resource is not an issue, at least not when compared to the scatternet. Therefore, broadcast ARP replies received from the scatternet will always be passed by the address filtering function to the NAP-B.

For broadcast ARP replies received from the LAN, the address filtering process is much more complicated. The address filtering function first extracts the “target MAC address” from the ARP reply. This is the MAC address of the intended receiver of the ARP reply. In other words, this is the MAC address of the node that sent the ARP request (or possibly the ARP-route-request) that triggered the ARP reply. The target MAC address is extracted even though the destination address of the packet is a broadcast address. The target MAC address is then made subject to the same check as a destination address of a unicast packet. If the target MAC address was not found in the address table or if it was found in the address table and the address table indicated that the corresponding node is located on the scatternet side of the NAP, the packet is passed to the NAP-B. The address filtering function then has an option to convert the broadcast ARP reply into a unicast ARP reply by replacing the broadcast address with the target MAC address in the destination address field. The purpose of this option is to save resources (mainly bandwidth) in the scatternet.

If the target MAC address was found in the address table and the address table indicated that the corresponding node is located on the LAN side of the NAP, i.e., the side of the NAP from which the ARP reply was received (or if the target MAC address is the NAP's own MAC address), the address filtering function may still pass the packet to the NAP-B in order to facilitate duplicate address detection. To determine whether this should be done, the address filtering function extracts the sender IP address and the sender MAC address from the ARP reply. It then looks for the sender IP address in the ARP cache. If the sender IP address is not found in the ARP cache, the packet is not passed to the NAP-B. If the sender IP address is found in the ARP cache and the associated MAC address is the same as the sender MAC address, the packet is not passed to the NAP-B. If the sender IP address is found in the ARP cache and the associated MAC address is not the same as the sender MAC address, a possible duplicate IP address is detected and the packet is passed to the NAP-B (as a broadcast ARP reply) in order to facilitate duplicate address detection. Note that this procedure requires that the packet filtering procedure is performed before the ARP cache is updated with the received sender IP address—sender MAC address pair. This requirement should not be a problem, since the packet filtering occurs at a lower layer than the ARP.

If a broadcast ARP reply without a target MAC address is received, the packet is passed to the NAP-B (as a broadcast ARP reply) irrespective of which side of the NAP the packet was received from.

All broadcast ARP packets received by the address filtering function are also passed to the NAP-IPH after the above-described address filtering procedure has been performed.

Administrative Domains and NAP Service Areas

The concept of AD and NAPSA is known (see, e.g., U.S. patent application Ser. No. 09/952,707, entitled “Administrative Domains for Personal Area Networks,” filed with the U.S. Patent and Trademark Office on Sep. 14, 2001, in the name of Johan Sorensen). In this concept, scatternets and NAPs are associated with an AD. The AD is identified by an Administrative Domain ID (ADI) that is unique for different networks (i.e., different IP subnets). The nodes in the scatternets are attached to an AD through an Administrative Domain Attachment Point (ADAP), which is a NAP. The ADAP is represented as a 48-bit IEEE MAC address, i.e., a Bluetooth MAC address (BD_ADDR). This is the BD_ADDR of the scatternet side interface of the concerned NAP. Each node keeps track of its own ADAP. For a node that is a NAP, the ADAP is the NAP's own BD_ADDR. All nodes with the same ADI and ADAP are members of the same NAPSA. This means that NAPs connected to the same LAN have the same ADI, but a different ADAP. NAPs that are connected to different LANs have a different ADI as well as a different ADAP. Stand-alone scatternets that do not have connectivity to any LAN can form a general connectivity (public) scatternet with the ADI and ADAP set to NULL. A mobile Bluetooth node can also choose to host a non-public scatternet and choose the value for the ADI and use its own BD_ADDR as the ADAP.

Under the Administrative Domain concept, packet forwarding at the NAL layer is enabled or disabled based on the domain in which the nodes are members. The idea is to prevent broadcast loops and duplicate packet deliveries. Prevention is based on a set of packet forwarding rules (although it is always possible to bypass these rules by forwarding packets at the IP layer, e.g., via an IP router). Examples of forwarding rules for a connection between two nodes are described below. Note that the forwarding rules described below are with respect to the non-NAP nodes, i.e., the regular BT units.

If the ADI is the same for both nodes, but the ADAP is different, then the nodes are members in the same Administrative Domain, but members in different NAPSAs. Broadcast packets of the NAPSA broadcast type and the AD broadcast type are blocked, but all other packets may be forwarded.

If both nodes have the same ADI and ADAP, then the nodes are members in the same Administrative Domain as well as the same NAPSA. There are no restrictions on the traffic between the nodes. A special case of this rule is when the ADI and ADAP is NULL for both nodes.

If the ADI is different for the two nodes, then the nodes are members in different Administrative Domains. All NAL packets carrying higher layer protocols are blocked. However, some NAL control packets will be forwarded. Broadcast packets of the NAPSA broadcast type and the AD broadcast type are of course blocked.

Before joining a NAPSA, a node must decided which NAPSA to join. In accordance with embodiments of the invention, the NAPSA is chosen based on which NAP is the closest to the node. Thus, the hop count between the NAP and a node becomes the main selection parameter. The hop count is exchanged between the nodes and the NAP during initial establishment of the network, and again when changes occur in the network topology. Nodes will try to be members in the NAPSA in which the nodes will have the lowest hop count to the NAP. Nodes can switch NAPSA if a better NAPSA is detected. This means that the ADs may be dynamically adapted.

Thus, embodiments of the invention also improve dynamic maintenance of the NAPSAs in the AD.

The mechanisms that allows a Bluetooth node to get information about possible NAPSAs are: NAP beacons, NAP discovery, and NAPSA neighbor information.

With respect to NAP beacons, all NAPs are required to send NAP beacon messages in specified intervals. The beacon interval should be relatively infrequent in order to minimize the broadcast traffic within the scatternet. The beacon messages are broadcast throughout the entire NAPSA, i.e., all nodes that are members of the NAPSA receive the beacon messages. The beacon messages allow the nodes to detect changes in the hop count of the route to the current NAP. For example, the mobile nodes that are members in a NAPSA will store a route to the NAP and the actual hop count to the NAP. The routes to the NAP are established by the beacon messages traveling through the NAPSA. As a node receives the beacon message, the route traversed by the beacon message, which effectively represents a route between the node and the NAP sending the beacon message, is stored in the node. The nodes will then use the NAP beacons to check if the hop count of the route to the NAP has changed. If yes, the nodes will update the route entry for the route to the NAP. As a beacon message is forwarded by a node, the hop count included in the beacon message is increased by one. Thus, the beacon messages are updated when nodes forward them to other nodes in the NAPSA.

The nodes can also detect when the current NAP is unreachable. For example, if a node detects that two consecutive NAP beacons have been missed, the node will remove the NAP route and will stop using that NAPSA. The node can subsequently join some other NAPSA if there is one available.

Nodes that are looking for a NAP (in order to join its NAPSA) can speed up the process by sending a special NAP discovery message. For example, when a connection/route to the current NAP is lost, a node is required to send a NAP discovery message (using the NAPSA broadcast type). The discovery message can also be sent when there is no current NAP and the node would like to join a NAPSA with a NAP. A NAP that receives a NAP discovery message will immediately send an extra NAP beacon message. Thus, there may be extra NAP beacon messages sent between regularly scheduled NAP beacons.

The extra beacon can also speed up the process in which other nodes in the NAPSA will detect that the NAP is unreachable. For example, when one node realizes that the route or link to the current NAP is down, it broadcasts a NAP discovery message throughout the NAPSA. Only the node detecting the link/route error will broadcast the NAP discovery message. All nodes in the NAPSA will receive the NAP discovery message and realize that some node has detected a change in the path to the NAP. The nodes will thus locally set a flag indicating that they are to expect an extra NAP beacon. That is to say, the nodes are expecting to receive two NAP beacons within the span of one NAP beacon interval. All nodes that fail to receive these two beacons will remove the current NAPSA information and try to join some other NAPSA (if available). Note that it does not matter whether the regular beacon is received before or after the extra beacon. The two beacon messages look exactly the same. The only difference is that the frequency in which the beacons are sent is temporarily increased.

The node that first detected the route error will of course also send a route error message (discussed previously) to its affected neighbor nodes in addition to the NAP discovery message. In this way, all nodes using a route through this node will also realize that a route is down.

Note that the NAP beacons are only broadcast in the NAPSA. Thus, only current NAPSA members will receive the up-to-date information regarding the NAP and the number of hops required to reach the specified NAP. Therefore, in accordance with embodiments of the invention, NAPSA edge nodes (nodes along the border of a NAPSA) are used to share NAPSA information with nodes that are not NAPSA members. The NAPSA edge nodes have neighbor nodes that are in another NAPSA or that do not belong to any NAPSA. The NAPSA edge nodes can be used to share NAPSA information with their non-NAPSA or different NAPSA neighbors. Such an arrangement is referred to as NAPSA neighbor information.

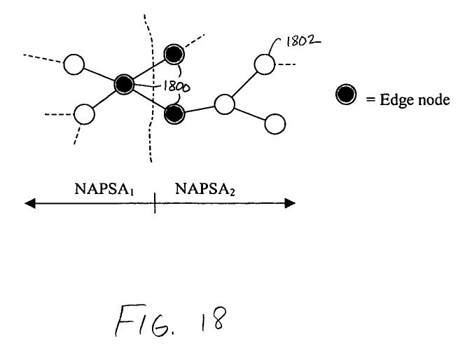

Referring now to FIG. 18, a plurality of NAPSA edge nodes 1800 are shown as shaded circles. The non-edge nodes 1802 are shown as empty circles. The border between the NAPSAs is represented by a dotted line. The NAPSA edge nodes use NAPSA neighbor information messages to share information with each other regarding their NAPSAs. The neighbor information messages include the ADI, ADAP and the hop count to the NAP for each node. This information is shared when two nodes are initially connected, and again between edge nodes of different NAPSAs when changes in the information occur. The NAPSA edge nodes will thus have information regarding their current NAPSA as well as neighboring NAPSAs. This makes it possible for the edge nodes to decide whether they want to switch NAPSAs.

The NAPSA neighbor information is also exchanged when a connection between two nodes is created. Based on the NAPSA information, the two nodes decide which NAPSA they should belong to. The nodes also decide whether the connection is one that crosses an AD border, a NAPSA border or no border at all. The rules for this initial decision are as follows.

If none of the nodes have an ADI, then no NAPs are available for the nodes. There will be no restrictions on the traffic between the nodes.

If one node has an ADI, but the other node does not, then the node that does not have an ADI will join the AD of the other node. There will be no restrictions on the traffic on the link between the nodes. It should be noted that some nodes or types of device may choose not to join any AD and should be able to do so.

If both nodes have the same ADI, but different ADAP and a hop count difference of one or zero hops, then the nodes are connected to the same Administrative Domain, but via different ADAPs. The nodes will keep their current NAPSA. Broadcast packets of the AD broadcast type and the NAPSA broadcast type will not be sent between the two nodes.

If both nodes have the same ADI, but different ADAP and a hop count difference larger than one hop, then the nodes are connected to the same Administrative Domain, but via different ADAPs. The hop count difference reveals that the node with a higher hop count may gain in terms of hops to the NAP by switching NAPSAs. The procedure for switching NAPSAs is described later herein.

If both nodes have the same ADI and ADAP and a hop count difference of one or zero hops, then the nodes belong to the same NAPSA. There will be no restrictions on the traffic between the nodes.

If both nodes have the same ADI and ADAP and a hop count difference that is greater than one hop, then the nodes belong to the same NAPSA. There will be no restrictions on the traffic between the nodes. The nodes with higher hop counts will also change their route to the NAP by setting the next hop to point to the new neighbor. The hop count is set to the hop count of the new neighbor's hop count plus one.

If the nodes have different ADI, then the connection between them should not be maintained at all for protocol layers above the NAL, i.e., no packets carrying higher layer protocols will be sent between the nodes. However, some NAL control packets will be allowed across the nodes. Specifically, the NAPSA information message that is sent to neighbors in other ADs will be allowed.

The information regarding the neighbor NAPSAs is stored in a NAPSA table that keeps track of the NAPSA information mentioned earlier. This information is also updated when the actual link to the neighbor goes down.

Note that the NAPSA neighbor information messages are acknowledged by the nodes, as opposed to the NAP beacon messages that are not acknowledged. The purpose of the acknowledgement is to ensure that the NAPSA edge nodes actually get the updated information. Recall that the NAPSA neighbor information messages are only sent when changes have been detected. The NAP beacon messages are sent continuously with the same periodicity, which means that the nodes will receive a new beacon even if they happen to miss the present one. A node acknowledges the neighbor information message by sending a neighbor information message with the node's own information.

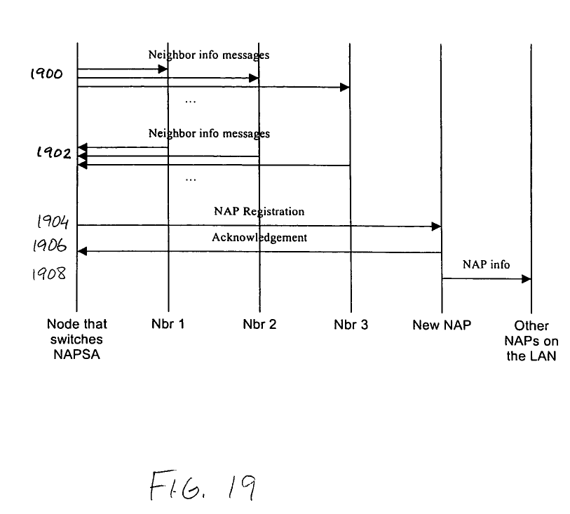

In determining whether to switch NAPSAs, the NAPSA edge nodes belonging to the same AD will first store the information that was received from the NAPSA neighbor information messages in a NAPSA table. The nodes will then compare the received information NAPSA_{new} with the existing information NAPSA_{current} in the NAPSA table. The nodes will then make the decision to switch NAPSAs if the hop count for NAPSA_{new} (which is one hop greater than the hop count received in the neighbor information message) is lower than the hop count for NAPSA_{current}. The sequence of steps that needs to be taken by a node in order to switch NAPSAs are illustrated in FIG. 19.

Referring to FIG. 19, the node that will be switching NAPSAs, or the switching node, is indicated on the far left. Also present are the neighbor nodes Nbr 1, Nbr 2, Nbr 3, and the new NAP to which the switching node will be switching. In the present example, a change in the route information of the switching node's NAP (e.g., the route to the NAP is down) causes the switching node to switch to the NAPSA of a neighbor node. The switch can also be triggered by a NAPSA neighbor information message indicating a decreased hop count to the NAP of a neighbor NAPSA. The triggering event causes the node to compare the hop count to its current NAP with the hop count(s) to the NAP(s) in the NAPSA(s) of the neighboring edge node(s). If the lowest hop count is to an NAP other than the current NAP (or if the current NAP is unreachable), the node decides to switch to the NAPSA with the NAP to which the hop count is the lowest. The switching node then sends a NAPSA neighbor information message to each of its neighbor nodes at step 1900. The nodes that are neighbors to the switching nodes acknowledge reception of the information message by sending their own NAPSA neighbor information messages back to the switching node at step 1902. From the new ADAP in the NAPSA neighbor information message sent by the switching node, the neighbors of the switching node can determine that the switching node has switched to a new NAPSA. Note that neighbor nodes receive the neighbor information message. By looking at the ADAP in the message, the neighbor nodes can see that the switching node has changed to a different NAPSA than before (since a node stores information about its neighbors, including the neighbors' ADAP).

The switching node will thereafter send a registration message (at step 1904) to the new NAP. The switching node can assume that the first hop in the route to the new NAP is the neighbor node that has indicated the lowest hop count to the new NAP in the acknowledging NAPSA neighbor information messages received at step 1902. This is because the neighbor node (e.g., Nbr 1) that sent the NAPSA information message is likely to have a route to the new NAP. Therefore, the switching node can simply use that neighbor node (e.g., Nbr 1) as the next hop to the new NAP. If it turns out the implicit route is invalid, a route error message will be sent back to the switching node by the node that fails in forwarding the registration message. This route error message will trigger the switching node to send a route request message into the NAPSA to get a route to the new NAP. The switching node will then send another NAP registration when a reply is received for the route request message.

A NAP registration message usually includes the BD_ADDR of the sending node. This means that the NAL registration message can essentially be empty, since the BD_ADDR of the sending node is already included as the source address in the NAL header. Note that the NAP registration message has to be acknowledged, which means that the NAP registration should be resent if for some reason no acknowledgement is received within a certain period of time. Thus, the new NAP, upon receiving the registration message, will generate a reply that is sent back to the switching node at step 1906. The new NAP also sends an INAPP information message to other NAPs on the LAN to inform them that the switching node has now switched to the NAPSA of the new NAP at step 1908. The reason for the switching node sending the registration message to the new NAP and the new NAP sending the INAPP information message to the other NAPs is so that the address tables of the packet filtering functions in the NAPs can be updated immediately instead of through the regular address learning process. If the registration message was not sent, packets from the LAN to the switching node would be blocked by the address filtering function 916 in the new NAP. If the INAPP message was not sent, packets from the switching node's old NAPSA that are addressed to the switching node (which should now be routed via the LAN) would be blocked by the address filtering function 914 in the switching node's old NAP.

Each neighbor node that receives the NAPSA neighbor information message from the switching node will go through the same procedure to decide if a NAPSA switch is needed. The NAPSA switch may thus propagate through the network, e.g. when the old NAP has become unreachable, until a new NAPSA border is established. Preferably, the new NAPSA border is the point where nodes on both sides of the border will have the same hop count to their respective NAPs, or a hop count that only differs by one.

The information that is contained in the NAPSA neighbor information messages is stored by each node in a NAPSA information table. The NAPSA information table stores at least the following information for each available NAPSA (i.e., the node's current NAPSA and other NAPSAs to which neighboring edge nodes might belong): ADI, ADAP, hop count, and next hop. The reason to store this information is for the node to be able to determine which NAPSA is the most optimal in terms of hop count when some change occurs (e.g., in the node's route to the NAP, in neighbor nodes' (same NAPSA) routes to the NAP, in the routes to NAPs of neighbor NAPSAs, or when new nodes connect or old nodes disconnect.

A node may also switch to the NAPSA of a neighbor node that is in another AD. However, the decision to perform an inter-AD NAPSA switch is not based simply on the hop count to the NAPs. In this case, the switch decision has to be based on other information as well, including configuration criteria (e.g., operator preferences or server preferences), or intervention by the user.

Inter-NAP Protocol

The fourth main component of the invention is the Inter-NAP Protocol (INAPP), the purpose of which is to deliver messages between the various NAPs on the LAN. For example, INAPP messages can be used to exchange information regarding which nodes the NAPs have in their NAP service areas, and to deliver routing information. In order to achieve this purpose, a new value (to be assigned by IEEE standards body) for the protocol type field in the Ethernet header is allocated to ensure that these INAPP messages are discarded by the nodes that don't support the INAPP protocol. The most important feature of INAPP is the encapsulation mechanism, which allows NAL control packets to be encapsulated in Ethernet packets and transferred across the LAN unchanged. The types of NAL packets that can be encapsulated include route requests, route replies, and route failure packets.

INAPP messages can also be used to inform other NAPs on the LAN that a node has joined the NAPSA of a certain NAP. This notification allows the other NAPs on the LAN to adjust their packet filtering address tables more quickly than would otherwise have occurred.

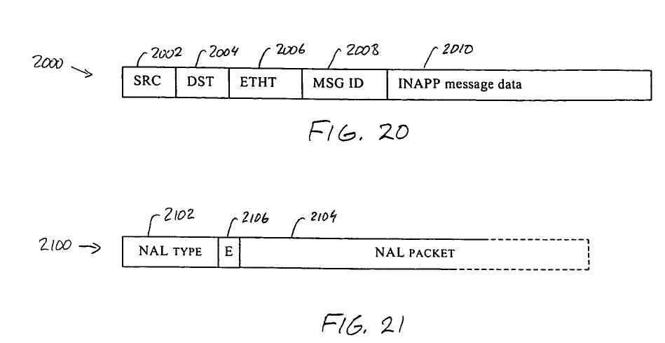

The INAPP messages can be sent over the LAN using the broadcast type (other nodes will discard the packets since they do not recognize the protocol type), multicast type (i.e., a multicast group for NAPs), or unicast type. INAPP messages are sent on the LAN using a standard Ethernet packet format. The standard Ethernet format of an INAPP message is shown in FIG. 20. As can be seen, the Ethernet format 2000 includes an Ethernet source SRC address 2002, a destination DST address 2004, and an Ethernet type ETHT field 2006. Also present is a message identification field MSG ID 2008, which is a number uniquely identifying the NAP message, and an INAPP message data field 2010 which contains the INAPP message.

There are two different types of INAPP messages: INAPP information message, and INAPP NAL encapsulation message (which is an INAPP message with an encapsulated NAL message). The INAPP information message is made of one field—the HOST identity (note that the SRC field 2002 for this message is the NAP identity). The INAPP NAL encapsulation message is also made of one field—an encapsulated NAL message. The “HOST” identity is the MAC address (i.e., Bluetooth BD_ADDR) of the node that has just joined the NAPSA of the NAP sending the INAPP information message. Recall that the INAPP information message was triggered by a NAP registration message (step 1904) from this Bluetooth node to the NAP.

The INAPP information message is used to inform another NAP that a specified node is now in the sending NAP's service area. When a NAP receives this message, it stores the information in a locally kept database (e.g., the address table maintained by the packet filtering functions). The information will then be used to prevent traffic addressed to this node from being forwarded into the receiving NAP's own service area and, in certain cases, to prevent blocking of packets that originate in the receiving NAP's own service area and that are addressed to the node indicated in the INAPP information message. The message can be either broadcast or multicast (to a NAP multicast group). No acknowledgement is needed for this message.

As for the INAPP NAL encapsulation message, when a NAP receives a route request/reply that is to be forwarded to the LAN, the request/reply message is encapsulated inside a message. The route request/reply may or may not have a piggybacked ARP request/reply. Route failure messages concerning a transit-LAN route can also be encapsulated inside an INAPP NAL encapsulation message.

Another type of message used is NAL messages. NAL messages are used to exchange information within the Bluetooth scatternet. FIG. 21 shows the format of a NAL message, including a NAL type field 2102, which is a number uniquely identifying the NAL message, and the NAL packet data field 2104, which is message dependent. The ‘E’ represents an extension header bit 2106 and is set in the case where an optional NAL extension header is used. The optional header is used when the basic NAL functionality is extended, e.g., when an ARP request is piggybacked on a route request or when an ARP reply is piggybacked on a route reply. Embodiments of the invention provide five new NAL messages: NAPSA neighbor information message, NAP registration message, NAP beacon message, NAP discovery message, and NAP acknowledgement.

The NAPSA neighbor information message is made of the ADI, the ADAP (which is the NAP identity or BD_ADDR), and the hop count to the NAP. The NAP beacon message is made of the ADI and the updated hop count as it is forwarded. The NAP registration message, the NAP discovery message and the NAP acknowledgement message usually includes only the NAL header, since no additional information is needed in these messages. NAP discovery messages and NAP beacons are broadcast within the NAP service area only. For all five types of NAL messages, it should be noted that nodes without a NAP, i.e., nodes belonging to a NAPSA without a NAP or no NAPSA at all (e.g. nodes in the non-NAP area 814 in FIG. 8), do not forward these message. Consequently, if none of a node's neighbors have a NAP (or is itself a NAP), the node cannot reach a NAP using these neighbors.

The foregoing discussion can be summarized in Table 5, which shows the actions that are taken by the various nodes and NAPs upon reception of the different types of messages.

TABLE 5

| Message | | |
|---|---|---|
| received | Node action | NAP action |
| NAPSA | Update the information in the | Update the information |
| neighbor | NAPSA neighbor table | in the NAPSA |
| Information | (database). | neighbor table |
| Message | | (database). |
| NAP | Forward the message. | Update the information |
| Registration | | in the address table |
| Message | | of the packet filtering |
| | | function and send a |
| | | NAP acknowledgement. |
| NAP Beacon | Check the new/old NAPSA | Discard the message. |
| | information; switch NAP if | |
| | needed and update the hop | |
| | count; forward the message to | |
| | neighbor nodes in the same | |
| | NAPSA. | |
| NAP Discovery | Forward the message to | Send a NAP beacon |
| | neighbors in the same | message. |
| | NAPSA; set a timer to remove | |
| | the information about the | |
| | current NAP; if no beacon is | |
| | received within the specified | |
| | time, remove the stored | |
| | information about the current | |
| | NAP. | |
| NAP | Forward the message. | Discard the message. |
| acknowled- | | |
| gement | | |
| INAPP | Not applicable. | Update the packet |
| information | | filtering address |
| | | tables, if needed. |

Embodiments Without INAPP

In some embodiments of the invention, no INAPP is used. These embodiments will result in some modifications to the above described procedures. For example, when INAPP is not used, the rules governing how broadcast ARP replies are sent in response to ARP-route-requests are not needed. Thus, the broadcast ARP reply does not have to be sent after the ARP-route-reply, and could instead be sent before the ARP-route-reply. The reason for sending a broadcast ARP reply in these embodiments is to facilitate duplicate IP address detection. Furthermore, NAL control messages can not be transferred across the LAN unchanged in an INAPP NAL encapsulation message. This affects the broadcast loop prevention mechanism in that the original sequence number of a NAL broadcast packet is not kept when the packet re-enters the scatternet after having traversed the LAN (and two NAPs) Thus, when checking whether a received broadcast packet has been processed before, a scatternet node does not have to check the broadcast type of the received broadcast packet. The combination of the source address and the sequence number is enough.

Moreover, since INAPP encapsulated packets are no longer possible, transit-LAN routing has to be modified. As mentioned previously, when a source node and a destination node are located in the same scatternet and the same AD, but in different NAPSAs, there are two ways to establish a route between the two nodes: through the scatternet, or through the LAN (transit-LAN). Both of these routes can be established using the scatternet-AD broadcast type for the route request. However, when encapsulated route requests and route replies are not used across the LAN, the route request and route reply that establish the LAN route will not indicate the correct hop count for that route.

The above situation can be illustrated by referencing back to FIG. 16, where it is seen that two routes to the destination node D may be established. Because INAPP encapsulation was not used, the route request via the LAN will indicate the number of hops only between NAP 2 and destination node D (one hop in this example), and the route reply via the LAN will indicate the number of hops only between NAP 1 and the source node S (two hops in this example). The reason for this irregularity is because NAL control packets, such as route requests and route replies, are designed for use in the scatternet. Thus, while the NAL control packets can be converted and used on the LAN (as previously described), the accumulated hop count will not be correctly conveyed.

The incorrect hop count for the LAN can cause a node to wrongly select the route via the LAN. However, each node does know the hop count to its own NAP (henceforth referred to as “NAP distance”). Therefore, in some embodiments, the nodes inform each other of the hop count to their respective NAPs, i.e., their respective NAP distance. Thus, the destination node D would add the source node's “NAP distance” (two, in this example) to the hop count indicated by the route request received via NAP 2 to get the complete hop count for the route. (Recall that the path across the LAN between the two NAPs is considered to be zero hops due to the superior capacity of the LAN.) The source node S would likewise add the destination node's “NAP distance” (one, in this example) to the hop count indicated by the route reply received via NAP 1 to get the complete hop count for the route. The received “NAP distance” of another node would also be stored together with the route entry of the concerned node.

Since the “NAP distance” information is needed only when a route through both the scatternet and the LAN can be established, in some embodiments, the “NAP distances” are exchanged using the route request and the route reply that are sent via the scatternet. In these embodiments, the source node S includes its “NAP distance” in the route request, and the destination node D includes its “NAP distance” in the route reply.

Information about the source/destination node's status (or the status of the message) should also be associated with the “NAP distance” in the route request/reply messages. Thus, in some embodiments, a one-byte indicator in the packet is used to indicate both the node status (or message status) and the “NAP distance.” Table 6 below illustrates exemplary one-byte indicators that could be used in both the route requests and route replies to indicate a combined node status and “NAP distance.” The status indicator is the first three bits, while the remaining five bits indicate the “NAP distance.” Note that status code 010 indicates the status of the message, while the other status codes (except status code 111) indicate the status of the node originating the message.

TABLE 6

| | Meaning of | |
|---|---|---|
| Status Code | Status Code | NAP Distance |
| 000 | Node in same | 00000-11111 |
| | scatternet. | |
| 001 | Node in same | 00000-11111 |
| | scatternet, but | |
| | different NAPSA. | |
| 010 | Message forward- | Not applicable (set to, |
| | ed by NAP. | e.g., 11111) |
| 011 | Node in same | 00000-11111 |
| | NAPSA. | |
| 100 | Node does not | Not applicable (set to, |
| | have a NAP. | e.g., 11111) |
| 101 | Node status | 00000-11111 |
| | unknown. | |
| 110 | Intermediate | 00000-11111 |
| | node (destination | |
| | node's “NAP distance” | |
| | is indicated). | |
| 111 | Reserved for | Reserved for future use |
| | future use | |

Note in Table 6 that status code 000 applies only to route requests, and status codes 001, 011, and 110 apply only to route replies.

When a node receives a route request or a route reply with a “node status unknown” indication, it means the node originating the route request or route reply has lost contact with its NAP and is currently trying to reestablish contact, but does not know yet whether this will be successful.

When a node receives a route request or a route reply with the status indication “message forwarded by NAP,” the receiving node checks to see whether it has already received the NAP distance of the originating node in another route request or route reply. That is to say, the receiving nodes checks to see whether there already exists a route entry for the originating node with a NAP distance stored. If not, the receiving node checks to see whether there already exists a route entry for the originating node without a stored NAP distance. If yes, the (possibly incomplete) hop count of the new route is compared with the hop count of the old route. If the new route has the smaller hop count, the receiving node replaces the previous route and a “hop count possibly underestimated” indication is stored together with the new route entry. If the new route has the greater hop count, the old route is kept and the new route is discarded. If there was no existing route entry at all for the originating node, a new route entry is created with a “hop count possibly underestimated” indication. If a route entry with a stored NAP distance already exists for the originating node, the receiving node adds the NAP distance of the originating node to its own NAP distance to get the correct hop count for the route via the LAN. The receiving node can then compare the hop count of the route via the LAN with the hop count of the already established route. If the route via the LAN has a smaller hop count, the receiving node replaces the previous route and the NAP distance of the remote node is stored together with the new route entry. Otherwise the route via the LAN is discarded.

When a node receives a route request or a route reply including a valid NAP distance, without a “message forwarded by NAP” indication (which means that the route request or route reply has not been forwarded by a NAP), it checks whether there already exists a previous route entry for the node originating the route request or route reply. If yes, and if this route entry has a “hop count possibly underestimated” indication, the received NAP distance is added to the (possibly underestimated) hop count of the existing route before the hop counts of the two routes are compared. If the new route has the smaller hop count, the receiving node replaces the previous route and the NAP distance of the originating node is stored together with the new route entry. If the new route has the greater hop count, the old route is kept, the new route is discarded, the NAP distance of the originating node is stored together with the previous route entry and the “hop count possibly underestimated” indication is removed. If a route entry for the originating node already exists, but it does not have a “hop count possibly underestimated” indication, the hop counts of the two routes are simply compared. If the new route has the smaller hop count, the receiving node replaces the previous route and the received NAP distance is stored together with the new route entry. If the new route has the greater hop count, the new route is discarded and the old route is kept. If the old route entry did not contain a NAP distance, the received NAP distance is stored together with the old route entry. If there is no previously existing route at all to the originating node, the new route is used and the NAP distance is stored together with the route entry.

If a node receives a route request or a route reply without a valid NAP distance (see, e.g., Table 6, status codes 010 and 100), the route selection procedure proceeds as explained above, except that a hop count that may be underestimated has to be used.

An intermediate node that receives a “NAP distance” in a route request or a route reply will forward the request/reply, as before. In addition, the intermediate node stores the received “NAP distance” in the route entry that was created for the route request/reply. This NAP distance will be included in any route replies that the intermediate node sends in response to a route request for the originating node.

Furthermore, when INAPP is not used, the procedures for route establishment discussed previously have to be modified because neither ARP-route-requests nor non-ARP-route-requests will be transferred across the LAN using INAPP encapsulation. The following description discusses only the modifications that need to be made; all other aspects of the route establishment procedures remain as described previously.

In the first case, when the NAP-B receives an ARP-route-request from the NAP-PFS, the NAP-B creates a temporary route entry for the source node as before (unless it already has a route entry for the source node). The NAP-B then converts the ARP-route-request into a regular ARP request and forwards the converted request to the LAN.

On the LAN, in order to be able to distinguish the desired ARP reply from other ARP replies, the NAP-B stores the “target IP address” and the “sender MAC address” of the ARP request. The addresses are stored in a table for pending ARP requests triggered by route requests from the scatternet. The NAP-B also stores a pointer to the route entry. This pointer may be, for example, the MAC address of the route entry. The pointer will be used to send a possible ARP-route-reply to the source node. The NAP-B also stores an indication of the type of reply to send, such as an ARP-route-reply or a non-ARP-route-reply. An exemplary table for pending ARP requests is illustrated in Table 7.

TABLE 7

| Target | Source | | | |
|---|---|---|---|---|
| IP | MAC | MAC Address of | | |
| Address | Address | Route Reply | Type of Reply | Timer |
| IP | MAC | MAC Address 1 | ARP-route- | Entry 1 timer |
| Address 1 | Address 1 | | reply | |
| IP | MAC | MAC | ARP-route- | Entry 2 timer |
| Address 2 | Address 2 | | reply | |
| IP | MAC | MAC Address 3 | ARP-route- | Entry 3 timer |
| Address 3 | Address 3 | | reply | |
| ... | ... | ... | ... | ... |
| IP | MAC | MAC Address 7 | non-ARP- | Entry 7 timer |
| Address 7 | Address 7 | | route-reply | |

In most cases, the MAC address indicating the concerned route entry will be the same as the “sender MAC address,” but in some cases, the two MAC addresses will be different. The latter cases are the only cases where the type of reply indicated in the exemplary Table 7 will be a non-ARP-route-reply. The lifetime of each entry in the table for pending ARP requests is governed by a timer. The timer for an entry is started when the entry is stored and when the timer expires, the entry is removed from the table for pending ARP requests. The resulting timeout period should preferably be the same as for a temporary route entry, i.e., the timer should be started at the value shortInterval.

If the ARP request is received by the NAP-B in another NAP on the LAN (which means that the NAP-PFL in that NAP has accepted the ARP request), the new NAP-B will convert the ARP request into an ARP-route-request and broadcast it in the scatternet. Any ARP-route-reply from the scatternet will be converted to a unicast ARP reply and forwarded to the LAN. If a broadcast ARP reply is also returned, the broadcast ARP reply will be forwarded to the LAN as a broadcast ARP reply in addition to the unicast ARP reply.

On the other hand, if the destination node is located on the LAN, the destination node will respond with only one reply, either a unicast ARP reply or a broadcast ARP reply. The destination node (on the LAN) will respond with a broadcast ARP reply if the ARP request concerns a link-local IP address, and with a unicast ARP reply otherwise.

Thus, the NAP-B in the first NAP (i.e., the NAP-B sending the ARP request) can expect to get between zero to two ARP replies from the LAN. If only one ARP reply is received, the responding node may be located either on the LAN or in a scatternet. If two ARP replies are received, the responding node can only be a scatternet node. In the latter case, one of the ARP replies will be a unicast ARP reply and the other will be a broadcast ARP reply.

If a unicast or broadcast ARP reply from the LAN is received by the NAP-B of the first NAP (via the NAP-PFL), the NAP-B checks to see whether the “sender IP address” and the “target MAC address” of the ARP reply match the target IP address and the source MAC address of any entry in the table for pending ARP requests triggered by route requests from the scatternet. If no matching entry is found, the packet is treated just like any ARP reply, i.e., it is forwarded to the LAN as a (unicast or broadcast) ARP reply. If, on the other hand, a matching entry is found in the table for pending ARP requests, the ARP reply is converted to an ARP-route-reply (as indicated by the “type of reply” indication in the matching entry) and forwarded to the source node of the original ARP-route-request in the scatternet. The ARP-route-reply is forwarded using the route entry associated with the MAC address of the matching table entry. In this way, the route is established.

The matching table entry is then removed from the table irrespective of the value of the entry's timer. If the ARP reply was a broadcast ARP reply, then the ARP reply is also forwarded into the scatternet as a broadcast ARP reply in addition to the already sent ARP-route-reply. Broadcast ARP replies that are received from the scatternet will, of course, not be coupled with the pending ARP-route-request; only those from the LAN, i.e., passed to the NAP-B by the NAP-PFL, are considered.

If the NAP-B in the first NAP does not receive any reply at all before the entry in the table for pending ARP requests triggered by route requests from the scatternet times out, it does not forward anything to the scatternet and no route is established.

In the case of non-ARP-route-requests, if the NAP-B already has a route entry for the destination node (or if the NAP itself is the destination node), the NAP-B will send a non-ARP-route-reply to the source node. If the NAP-B does not know the IP address of the destination node, it will not be able to convert the non-ARP-route-request into an ARP request. In that case, the NAP-B has the option to try to retrieve the IP address of the destination node from the ARP cache, so that an ARP request could be generated. When this option is used, the NAP-B checks to see whether the destination MAC address is included in the ARP cache of the NAP. If it is, the NAP-B retrieves the IP address of the destination node from the ARP cache. The NAP-B will then generate an ARP request with the retrieved IP address as the target address and the NAP's own MAC address as the sender MAC address. The NAP will use its own IP address as the new sender IP address and its own MAC address as the new source address. Effectively, the NAP generates an ARP request of its own and is not actually forwarding the ARP request on behalf of the source node. Hence, the general rule of not changing the source address of a forwarded packet remains satisfied.

The NAP-B then stores the “target IP address” (i.e., the IP address of the destination node) and the “sender MAC address” (i.e., the MAC address of the NAP itself) of the ARP request in the table for pending ARP requests (e.g., Table 7) triggered by route requests from the scatternet (as has previously been described). The “type of reply” indication stored in the table entry is in this case “non-ARP-route-reply.” The MAC address stored as the pointer to the route entry to be used to send a possible ARP-route-reply is the source MAC address of the received non-ARP-route-request. Thus, in this case, the route entry MAC address is not the same as the source MAC address in the table entry. Note that it is only when this option is used (i.e., the option to retrieve the destination IP address from the ARP cache in order to generate an ARP request) that a separate route entry MAC address is actually needed in the table for pending ARP requests (triggered by route requests from the scatternet). In all other cases, the route entry MAC address will be the same as the source MAC address in the table entry.

The above description with respect to non-ARP-route request is now almost identical to the case for the ARP-route-request. For example, the behavior of any destination node on the LAN or any another NAP receiving the ARP request is the same, and the ARP reply or ARP replies they return are the same. The main difference is the modification to the internal procedure of the first NAP, i.e., the NAP that sent the ARP request.

A modification is also needed if a unicast ARP reply arrives at the first NAP. Since this unicast ARP reply is addressed to the NAP itself, the NAP-PFL sends the packet to the NAP-IPH instead of the NAP-B. In addition to its normal processing of ARP replies, the NAP-IPH will pass the unicast ARP reply to the NAP-B, so that the NAP-B can continue processing it as usual. In this case a non-ARP-route-reply is sent to the source node in the scatternet using the route entry indicated by the MAC address in the matching table entry. But in this case, if no matching table entry is found, the unicast ARP reply is not forwarded to the scatternet, since it is addressed to the NAP itself. If no broadcast ARP reply is received by the NAP, the procedure is the same as for the ARP-route-request case, except that a non-ARP-route-reply instead of an ARP-route-reply is sent to the source node in the scatternet.

If no ARP reply at all is received, the NAP-B will of course not send any non-ARP-route-reply (or any other route reply) to the source node and no route will be established. (Broadcast ARP replies received from the scatternet will of course not be coupled with the pending ARP-route-request—only replies from the LAN, i.e., passed to the NAP-B by the NAP-PFL, are considered.) If the NAP does not use the option to attempt to retrieve the destination IP address from the ARP cache, or if the option is used, but the destination IP address could not be retrieved, then the NAP cannot verify the destination node's existence on the LAN (or in a remote scatternet). The NAP then sends an unconfirmed proxy non-ARP-route-reply to the source node to indicate that the NAP may have a route to the destination node, but the route cannot be verified. An unconfirmed proxy non-ARP-route-reply is (as was explained previously) a non-ARP-route-reply with an indication that the route has not been confirmed by the destination node or a node with a route to the destination node. In this way, an unconfirmed route has been established.

Modifications to the Administrative Domain and NAP service area aspects of the invention are also needed when INAPP is not used. Specifically, modifications are needed to the INAPP information messages that are sent from one NAP to inform other NAPs that a node has changed NAPSAs. The INAPP information message is replaced with a “dummy” Ethernet packet that is useful only to the NAPs and does not affect other nodes on the LAN. The other nodes simply discard the dummy Ethernet packet. This dummy message can be achieved by broadcasting an Ethernet packet that has the BD_ADDR of the new node (i.e. the node that recently joined the NAPSA) as the Ethernet source address. The Ethernet payload can be any payload, but is preferably an ARP request packet with all address fields set to zero. Such a payload will cause the other NAPs (including the new node's old NAP, if any) on the LAN to include the MAC address of the new node in their address tables with “LAN side” indicated (if this was not already the case).

Although embodiments of the invention have been described thus far with respect to IP version 4 (IPv4), the invention is equally applicable to IP version 6 (IPv6) with a few minor modifications. In general, the conceptual solution for bridging a Bluetooth scatternet to a LAN is the same for the IPv4 and IPv6. The two main differences between IPv4 and IPv6 that affects the bridge solution are: broadcast addresses in IPv4 have been superseded by multicast addresses in IPv6, and ARP in IPv4 has been replaced by neighbor discovery in IPv6. These differences affect mainly the NAL routing protocol in the sense that the triggering mechanism for route discovery will be based on multicast packets such as the neighbor discovery packets. Also affected is the use of the ARP cache in the NAPs as well as the mechanisms that depend on information that can be snooped from ARP packets. However, the neighbor cache in IPv6 can be used in a similar way as the ARP cache and the information that is retrieved from ARP packets can also be retrieved from neighbor discovery packets. (See, e.g., RFC 2461: Neighbor Discovery for IP Version 6 (IPv6).)

As demonstrated by the foregoing, embodiments of the invention provide a method and apparatus for constructing a reticulated frame structure. While a limited number of embodiments have been disclosed herein, those of ordinary skill in the art will recognize that variations and modifications from the described embodiments may be derived without departing from the scope of the invention. Accordingly, the appended claims are intended to cover all such variations and modifications as falling within the scope of the invention.

What is claimed is:

1. A method of bridging a point-to-point network with a shared medium network, said point-to-point network having a plurality of nodes including at least one network access point, comprising:
connecting said point-to-point network to said shared medium network via said network access point;
receiving data packets from said shared medium network and said point-to-point network;
converting said data packets from a shared medium network format to a point-to-point network format, or vice versa; and
forwarding certain ones of said data packets, including ARP requests and ARP route requests, between said shared medium network and said point-to-point network.

2. The method according to claim 1, wherein said step of forwarding includes receiving said ARP request from a source node in said shared medium network at said network access point, converting said ARP request to said ARP route request in said network access point, sending said ARP route request to said point-to-point network, and indicating said shared medium network as a next hop node in a route entry for a source node of said ARP request.

3. The method according to claim 2, wherein said step of forwarding further includes receiving an ARP route reply from a destination node in said point-to-point network at said network access point in response to said ARP route request, converting said ARP route reply to an ARP reply in said network access point, and sending said ARP reply to said shared medium network.

4. The method according to claim 2, wherein said step of forwarding further includes receiving a broadcast ARP reply from a destination node in said point-to-point network at said network access point in response to said ARP route request, sending said broadcast ARP reply to said shared medium network as a broadcast ARP reply, receiving a unicast ARP route reply from said point-to-point network at said network access point in response to said ARP route request, converting said unicast ARP route reply to a unicast ARP reply in said network access point, and sending said unicast ARP reply to said shared medium network.

5. The method according to claim 1, wherein said step of forwarding includes receiving a unicast data packet from a node in said shared medium network at said network access point without a preceding ARP request, and sending said unicast packet to a destination node in said point-to-point network if a route entry exists for said destination node in said network access point.

6. The method according to claim 5, wherein said step of forwarding further includes broadcasting a non-ARP route request to said point-to-point network from said network access point to establish a route to said destination node if no route entry for said destination node exists in said network access point, and sending said unicast data packet along said established route, wherein a non-ARP route reply received by said network access point in response to said non-ARP route request is not sent to said shared medium network.

7. The method according to claim 1, wherein said step of forwarding includes receiving an ARP route request from a source node in said point-to-point network at said network access point, encapsulating said ARP route request, and sending said encapsulated ARP route request to said shared medium network.

8. The method according to claim 7, wherein said step of forwarding further includes converting said ARP route request into an ARP request, and sending said ARP request to said shared medium network after said encapsulated ARP route request has been sent.

9. The method according to claim 8, wherein no ARP request is sent to said shared medium network if it is determined that a destination node of said ARP request is located in any point-to-point network, and no encapsulated ARP route request is sent to said shared medium network if it is determined that said destination node is located in said shared medium network.

10. The method according to claim 8, wherein said step of forwarding further includes storing a target IP address and source MAC address for said ARP request in said network access point, receiving an ARP reply at said network access point, converting said ARP reply to an ARP route reply, and sending said ARP route reply to said point-to-point network if a sender IP address and target MAC address for said ARP reply matches said stored target IP address and source MAC address of said ARP request.

11. The method according to claim 10, wherein said target IP address and source MAC address for said ARP request are stored in said network access point in a table for pending ARP requests triggered by route requests received from said point-to-point network.

12. The method according to claim 11, wherein said network access point is a first network access point, said step of forwarding further includes receiving said encapsulated ARP route request at a second network access point, storing a target IP address and source MAC address for said encapsulated ARP route request in said second network access point, extracting said ARP route request from said encapsulated ARP route request, sending said ARP route request to said point-to-point network, and indicating another NAP as a next hop node in a route entry for said source node in said second network access point.

13. The method according to claim 12, wherein said target IP address and source MAC address of said encapsulated ARP route request are stored in a table for pending ARP route requests triggered by encapsulated ARP route requests.

14. The method according to claim 12, wherein said step of forwarding further includes receiving said ARP request at said second network access point, comparing a target IP address and source MAC address of said ARP request with said stored target IP address and source MAC address of said encapsulated ARP route request, and if they do not match, converting said ARP request to an ARP route request and sending said converted ARP route request to said point-to-point network.

15. The method according to claim 14, wherein said step of forwarding further includes receiving an ARP route reply from said point-to-point network at said second network access point, encapsulating said ARP route reply, and sending said encapsulated ARP route reply to said shared medium network.

16. The method according to claim 15, wherein said step of forwarding further includes receiving said encapsulated ARP route reply at said first network access point, extracting said ARP route reply from said encapsulated ARP route reply, determining whether a sender IP address and a target MAC address of said ARP route reply matches said stored target IP address and source MAC address of said ARP route request, and sending said ARP route reply to said point-to-point network if a match is found.

17. The method according to claim 14, wherein said step of forwarding further includes receiving an ARP reply from said point-to-point network at said second network access point in response to said ARP route request and sending said ARP reply to said shared medium network.

18. The method according to claim 17, wherein said step of forwarding further includes receiving said ARP reply at said first network access point, determining whether a sender IP address and a target MAC address of said ARP reply matches said stored target IP address and source MAC address of said ARP route request, sending said ARP reply to said point-to-point network if no match is found, and converting said ARP reply to an ARP route reply and sending said ARP route reply to said point-to-point network if a match is found.

19. The method according to claim 18, wherein said ARP reply received from said point-to-point network at said second network access point is a broadcast ARP reply, said step of forwarding further including sending said ARP reply as a broadcast ARP reply from said first network access point to said point-to-point network in addition to said ARP route reply if a match is found.

20. The method according to claim 1, wherein said step of forwarding includes receiving a non-ARP route request from a source node in said point-to-point network at said network access point, encapsulating said non-ARP route request, and sending said encapsulated non-ARP route request to said shared medium network.

21. The method according to claim 20, wherein said step of forwarding further includes sending an unconfirmed proxy non-ARP route reply from said network access point to said point-to-point network, generating an unconfirmed route entry for a destination node of said non-ARP route request in said network access point, and indicating said shared medium network as a next hop node in said unconfirmed route entry.

22. The method according to claim 21, wherein no unconfirmed proxy non-ARP route reply is sent to said point-to-point network if it is determined that said destination node of said non-ARP route request is located in any point-to-point network, and no encapsulated non-ARP route request is sent to said shared medium network if it is determined that said destination node is located in said shared medium network.

23. The method according to claim 21, wherein said network access point is a first network access point, said step of forwarding further includes receiving said encapsulated non-ARP route request at a second network access point, extracting said non-ARP route request from said encapsulated non-ARP route request, and sending said non-ARP route request to said point-to-point network.

24. The method according to claim 22, wherein said step of forwarding further includes receiving a non-ARP route reply from said point-to-point network at said second network access point, encapsulating said non-ARP route reply, and sending said encapsulated non-ARP route reply to said shared medium network.

25. The method according to claim 24, wherein said step of forwarding further includes receiving said encapsulated non-ARP route reply at said first network access point, replacing said unconfirmed route entry with a confirmed route entry for said destination node, extracting said non-ARP route reply from said encapsulated non-ARP route reply, and sending said non-ARP route reply to said point-to-point network.

26. The method according to claim 1, wherein said step of forwarding includes receiving an ARP route request from a source node in said point-to-point network at said network access point, creating a route entry for said source node if no previous route entry for said source node exists, converting said ARP route request into an ARP request, and sending said ARP request to said shared medium network.

27. The method according to claim 26, wherein said step of forwarding further includes storing, in said network access point, a target IP address and source MAC address for said ARP request, a pointer to said route entry for said source node, and a type of reply indicator.

28. The method according to claim 27, wherein said target IP address and source MAC address for said ARP request, said pointer to said route entry for said source node, and said type of reply indicator are stored in said network access point in a table for pending ARP requests triggered by route requests received from said point-to-point network.

29. The method according to claim 28, wherein said type of reply indicator indicates an ARP route reply, and said pointer to said route entry is a source MAC address of said ARP route request.

30. The method according to claim 29, wherein said network access point is a first network access point, said step of forwarding further includes receiving said ARP request at a second network access point connected to said shared medium network, converting said ARP request to an ARIP route request and sending said ARP route request from said second network access point to said point-to-point network.

31. The method according to claim 30, wherein said step of forwarding further includes receiving an ARP route reply from said point-to-point network at said second network access point in response to said ARP route request, converting said ARP route reply to an ARP reply, and sending said ARP reply to said shared medium network.

32. The method according to claim 31, wherein said step of forwarding further includes receiving a broadcast ARP reply from said point-to-point network at said second network access point in response to said ARP route request and sending said broadcast ARP reply to said shared medium network.

33. The method according to claim 30, wherein said step of forwarding further includes receiving an ARP reply at said first network access point, determining whether a sender IP address and target MAC address of said ARP reply matches said stored target IP address and source MAC address, and if a match is found, converting said ARP reply to an ARP route reply if the type of reply indicator indicates an ARP route reply and sending said ARP route reply to said point-to-point network.

34. The method according to claim 33, wherein said step of forwarding further includes removing said matching entry from said table for pending ARP requests triggered by route requests received from said point-to-point network.

35. The method according to claim 1, wherein said step of forwarding includes receiving a non-ARP route request from a source node in said point-to-point network at said network access point, retrieving a destination node 1P address for said non-ARP route request from an ARP cache, generating a new ARP request using said retrieved IP address as a target IP address and a MAC address of said network access point as a sender MAC address for said new ARP request, using an IP address of said network access point as a sender IP address and said MAC address of said network access point as a source MAC address for said new ARP request, and sending said new ARP request to said shared medium network.

36. The method according to claim 35, wherein said step of forwarding further includes storing, in said network access point, said target IP address and source MAC address for said new ARP request, a pointer to said route entry for said source node, and a type of reply indicator.

37. The method according to claim 36, wherein said target IP address and source MAC address for said new ARP request, said pointer to said route entry for said source node, and said type of reply indicator are stored in said network access point in a table for pending ARP requests triggered by route requests received from said point-to-point network.

38. The method according to claim 37, wherein said type of reply indicator indicates a non-ARP route reply, and said pointer to said route entry is a source MAC address of said non-ARP route request.

39. The method according to claim 27, wherein said step of forwarding further includes receiving a unicast ARP reply at said network access point, comparing a sender IP address and target MAC address of said unicast ARP reply with said stored target IP address and source MAC address, and if a match is found, converting said unicast ARP reply to a non-ARP route reply if said type of reply indicator indicates a non-ARP route reply, and sending said non-ARP route reply to said point-to-point network.

40. The method according to claim 35, wherein if said destination node IP address cannot be received from said ARP cache, said step of forwarding further includes sending an unconfirmed proxy non-ARP route reply from said network access point to said point-to-point network, generating an unconfirmed route entry for a destination node of said non-ARP route request in said network access point, and indicating said shared medium network as a next hop node in said unconfirmed route entry.

41. A system for bridging a point-to-point network with a shared medium network, comprising:
a plurality of nodes in said point-to-point network and said shared medium network, said nodes including at least one network access point connecting said point-to-point network to said shared medium network;
a bridging function in said network access point configured to convert said data packets from a shared medium network format to a point-to-point network format, or vice versa, and forward certain ones of said data packets, including ARP requests and ARP route requests, between said shared medium network and said point-to-point network.

42. The system according to claim 41, wherein said network access point receives an ARP request from a source node in said shared medium network, said bridging function configured to cause said network access point to convert said ARP request to an ARP route request, send said ARP route request to said point-to-point network, and indicate said shared medium network as a next hop node in a route entry for a source node of said ARP request in said network access point.

43. The system according to claim 42, wherein said network access point receives an ARP route reply from a destination node in said point-to-point network in response to said ARP route request, said bridging function further configured to cause said network access point to convert said ARP route reply to an ARP reply and send said ARP reply to said shared medium network.

44. The system according to claim 42, wherein said network access point receives a broadcast ARP reply from a destination node in said point-to-point network in response to said ARP route request, said bridging function further configured to cause said network access point to send said broadcast ARP reply to said shared medium network as a broadcast ARP reply, and when a unicast ARP route reply from said point-to-point network is received at said network access point in response to said ARP route request, said bridging function further configured to cause said network access point to convert said ARP route reply to an ARP reply and send said ARP reply to said shared medium network.

45. The system according to claim 41, wherein said network access point receives a unicast data packet from a node in said shared medium network without a preceding ARP request, said bridging function further configured to cause said network access point to send said unicast packet to a destination node in said point-to-point network if a route entry exists for said destination node in said network access point.

46. The system according to claim 45, wherein said bridging function is further configured to cause said network access point to broadcast a non-ARP route request to said point-to-point network to establish a route to said destination node if no route entry for said destination node exists in said network access point, and send said unicast data packet along said established route, wherein a non-ARP route reply received by said bridging function in response to said non-ARP route request is not sent to said shared medium network.

47. The system according to claim 41, wherein said network access point receives an ARP route request from a source node in said point-to-point network, said bridging function further configured to cause said network access point to send said ARP route request as an encapsulated ARP route request to said shared medium network.

48. The system according to claim 47, wherein said bridging function is further configured to cause said network access point to convert said ARP route request into an ARP request and send said ARP request to said shared medium network after said encapsulated ARP route request has been sent.

49. The system according to claim 48, wherein no ARP request is sent to said shared medium network from said bridging function if it is determined that a destination node of said ARP request is located in any point-to-point network, and no encapsulated ARP route request is sent to said shared medium network from said bridging function if it is determined that said destination node is located in said shared medium network.

50. The system according to claim 48, wherein said bridging function is further configured to cause said network access point to store a target IP address and source MAC address for said ARP request in said network access point, and when an ARP reply is received at said network access point, said bridging function is further configured to cause said network access point to convert said ARP reply to an ARP route reply and send said ARP route reply to said point-to-point network if a sender IP address and target MAC address for said ARP reply matches said stored target IP address and source MAC address of said ARP request.

51. The system according to claim 50, wherein said target IP address and source MAC address for said ARP request are stored in said network access point in a table for pending ARP requests triggered by route requests received from said point-to-point network.

52. The system according to claim 51, wherein said network access point is a first network access point and said encapsulated ARP route request is received at a second network access point, said second network access point having a bridging function that is configured to cause said second network access point to store a target IP address and source MAC address for said encapsulated ARP route request, send an ARP route request contained in said encapsulated ARP route request to said point-to-point network, and indicate another NAP as a next hop node in a route entry for said source node in said second network access point.

53. The system according to claim 52, wherein said target IP address and source MAC address of said encapsulated ARP route request are stored in a table for pending ARP route requests triggered by encapsulated ARP route requests.

54. The system according to claim 52, wherein said ARP request sent by said first network access point is received at said second network access point, said bridging function of said second network access point further configured to cause said second network access point to compare a target IP address and source MAC address of said ARP request with said stored target IP address and source MAC address of said encapsulated ARP route request, and if they do not match, convert said ARP request to an ARP route request and send said converted ARP route request to said point-to-point network.

55. The system according to claim 52, wherein an ARP route reply from said point-to-point network is received at said second network access point, said bridging function of said second network access point further configured to cause said second network access point to send said ARP route reply as an encapsulated ARP route reply to said shared medium network.

56. The system according to claim 55, wherein said encapsulated ARP route reply is received at said first network access point, said bridging function of said first network access point further configured to cause said first network access point to determine whether a sender IP address and a target MAC address of said encapsulated ARP route reply matches said stored target IP address and source MAC address of said ARP route request, and send said ARP route reply contained in said encapsulated ARP route reply to said point-to-point network if a match is found.

57. The system according to claim 54, wherein an ARP reply from said point-to-point network is received at said second network access point in response to said ARP route request, said bridging function of said second network access point further configured to cause said second network access point to send said ARP reply to said shared medium network.

58. The system according to claim 57, wherein said ARP reply is received at said first network access point, said bridging function of said first network access point further configured to cause said first network access point to determine whether a sender IP address and a target MAC address of said ARP reply matches said stored target IP address and source MAC address of said ARP route request, send said ARP reply to said point-to-point network if no match is found, and convert said ARP reply to an ARP route reply and send said ARP route reply to said point-to-point network if a match is found.

59. The system according to claim 58, wherein said ARP reply received from said point-to-point network at said second network access point is a broadcast ARP reply, said bridging function of said first network access point further configured to cause said first network access point to send said ARP reply as a broadcast ARP reply from said to said point-to-point network in addition to said ARP route reply if a match is found.

60. The system according to claim 41, wherein a non-ARP route request is received at said network access point from a source node in said point-to-point network, said bridging function further configured to cause said network access point to encapsulate said non-ARP route request and send said encapsulated non-ARP route request to said shared medium network.

61. The system according to claim 60, wherein said bridging function further configured to cause said network access point to send an unconfirmed proxy non-ARP route reply to said point-to-point network, generate an unconfirmed route entry for said destination node of said non-ARP route request, and indicate said shared medium network as a next hop node in said unconfirmed route entry.

62. The system according to claim 61, wherein no unconfirmed proxy non-ARP route reply is sent to said point-to-point network if it is determined that said destination node of said non-ARP route request is located in any point-to-point network, and no encapsulated non-ARP route request is sent to said shared medium network if it is determined that said destination node is located in said shared medium network.

63. The system according to claim 61, wherein said network access point is a first network access point and said encapsulated non-ARP route request is received at a second network access point, said second network access point having a bridging function that is configured to cause said second network access point to extract said non-ARP route request from said encapsulated non-ARP route request, and send said non-ARP route request to said point-to-point network.

64. The system according to claim 62, wherein a non-ARP route reply from said point-to-point network at said second network access point, said bridging function of said second network access point further configured to cause said second network access point to encapsulate said non-ARP route reply and send said encapsulated non-ARP route reply to said shared medium network.

65. The system according to claim 64, wherein said encapsulated non-ARP route reply is received at said first network access point, said bridging function of said first network access point further configured to cause said first network access point to replace said unconfirmed route entry with a confirmed route entry for said destination node, extract said non-ARP route reply from said encapsulated non-ARP route reply, and send said non-ARP route reply to said point-to-point network.

66. The system according to claim 41, wherein an ARP route request from a source node in said point-to-point network is received at said network access point, said bridging function configured to cause said network access point to create a route entry for said source node if no previous route entry for said source node exists, convert said ARP route request into an ARP request, and send said ARP request to said shared medium network.

67. The system according to claim 66, wherein said bridging function is further configured to cause said network access point to store a target IP address and source MAC address for said ARP request, a pointer to said route entry for said source node, and a type of reply indicator.

68. The system according to claim 67, wherein said target IP address and source MAC address for said ARP request, said pointer to said route entry for said source node, and said type of reply indicator are stored in said network access point in a table for pending ARP requests triggered by route requests received from said point-to-point network.

69. The method according to claim 68, wherein said type of reply indicator indicates an ARP route reply, and said pointer to said route entry is a source MAC address of said ARP route request.

70. The system according to claim 69, wherein said network access point is a first network access point and an ARP request is received at a second network access point connected to said shared medium network, said second network access point having a bridging function therein configured to cause said second network access point to convert said ARP request to an ARP route request and send said ARP route request from said second network access point to said point-to-point network.

71. The system according to claim 70, wherein an ARP route reply from said point-to-point network is received at said second network access point in response to said ARP route request, said bridging function of said second network access point further configured to cause said second network access point to convert said ARP route reply to an ARP reply, and send said ARP reply to said shared medium network.

72. The system according to claim 71, wherein a broadcast ARP reply from said point-to-point network is received at said second network access point in response to said ARP route request, said bridging function of said second network access point further configured to cause said second network access point to send said broadcast ARP reply to said shared medium network.

73. The system according to claim 70, wherein an ARP reply is received at said first network access point, said bridging function of said first network access point further configured to cause said first network access point to determine whether a sender IP address and target MAC address of said ARP reply matches said stored target IP address and source MAC address, and if a match is found, convert said ARP reply to an ARP route reply if the type of reply indicator indicates an ARP route reply and send said ARP route reply to said point-to-point network.

74. The system according to claim 73, wherein said bridging function of said first network access point is further configured to cause said first network access point to remove said matched entry from said table for pending ARP requests triggered by route requests received from said point-to-point network.

75. The system according to claim 41, wherein a non-ARP route request from a source node in said point-to-point network is received at said network access point, said bridging function further configured to cause said network access point to retrieve a destination node IP address for said non-ARP route request from an ARP cache, generate a new ARP request us said retrieved IP address as a target IP address and a MAC address of said network access point as a sender MAC address for said new ARP request, use an IP address of said network access point as a sender IP address and said MAC address of said network access point as a source MAC address for said new ARP request, and send said new ARP request to said shared medium network.

76. The system according to claim 75, wherein said bridging function further configured to cause said network access point to store said target IP address and source MAC address for said new ARP request, a pointer to said route entry for said source node, and a type of reply indicator.

77. The system according to claim 76, wherein said target IP address and source MAC address for said new ARP request, said pointer to said route entry for said source node, and said type of reply indicator are stored in said network access point in a table for pending ARP requests triggered by route requests received from said point-to-point network.

78. The system according to claim 77, wherein said type of reply indicator indicates a non-ARP route reply, and said pointer to said route entry is a source MAC address of said non-ARP route request.

79. The system according to claim 67, wherein a unicast ARP reply is received at said network access point, said bridging function further configured to cause said network access point to compare a sender IP address and target MAC address of said unicast ARP reply with said stored target IP address and source MAC address, and if a match is found, convert said unicast ARP reply to a non-ARP route reply if said type of reply indicator indicates a non-ARP route reply, and send said non-ARP route reply to said point-to-point network.

80. The system according to claim 75, wherein if said destination node IP address cannot be retrieved from said ARP cache, said bridging function further configured to cause said network access point to send an unconfirmed proxy non-ARP route reply from said network access point to said point-to-point network, generate an unconfirmed route entry for a destination node of said non-ARP route request in said network access point, and indicate said shared medium network as a next hop node in said unconfirmed route entry.
